(19) United States
(12) Patent Application Publication
(10) Pub. No.: US 2026/0107006 A1
(43) Pub. Date: Apr. 16, 2026

(54) REFERENCE PICTURE LISTS SIGNALING

(71) Applicant: InterDigital CE Patent Holdings, SAS, Paris (FR)

(72) Inventors: Fabrice Urban, Thorigne Fouillard (FR); Charles Salmon-Legagneur, Rennes (FR); Philippe Bordes, Laille (FR); Gwenaelle Marquant, la chapelle chaussee (FR)

(21) Appl. No.: 19/139,726

(22) PCT Filed: Nov. 29, 2023
(86) PCT No.: PCT/EP2023/083614

§ 371 Date: Jun. 16, 2025

(30) Foreign Application Priority Data
Dec. 16, 2022 (EP) 22306905.5

(51) Int. Cl. H04N 19/46; H04N 19/105; H04N 19/146; H04N 19/172; H04N 19/31

(52) U.S. Cl. CPC H04N 19/46; H04N 19/105; H04N 19/146; H04N 19/172; H04N 19/31

(57) ABSTRACT

A method comprising obtaining (711) from video data an information allowing determining a picture order count difference between a picture order count of a current reference picture of a list of reference pictures associated to a current picture and a picture order count of the current picture; determining (712) the picture order count difference from the information; and, determining (713) a picture order count of the current reference picture from the picture order count difference; wherein, the determining of the picture order count difference from the information is based at least on a temporal identifier of the current picture.

### 1. CROSS REFERENCE TO RELATED APPLICATIONS

This application claims priority to European Application No. 22306905.5, filed Dec. 16, 2022, which is incorporated herein by reference in its entirety.

### 2. TECHNICAL FIELD

At least one of the present embodiments generally relates to a method and a device for signaling reference pictures lists in video data.

### 3. BACKGROUND

To achieve high compression efficiency, video coding schemes usually employ predictions and transforms to leverage spatial and temporal redundancies in a video content. During an encoding, pictures of the video content are divided into blocks of samples (i.e. Pixels), these blocks being then partitioned into one or more sub-blocks, called original sub-blocks in the following. An intra or inter prediction is then applied to each sub-block to exploit intra or inter image correlations. Whatever the prediction method used (intra or inter), a predictor sub-block is determined for each original sub-block. Then, a sub-block representing a difference between the original sub-block and the predictor sub-block, often denoted as a prediction error sub-block, a prediction residual sub-block or simply a residual sub-block, is transformed, quantized and entropy coded to generate an encoded video stream. To reconstruct the video, the compressed data is decoded by inverse processes corresponding to the transform, quantization and entropic coding.

Inter prediction use temporal prediction wherein a block of a current picture is predicted from an area of at least one reference picture. Generally, a plurality of reference pictures is stored in a buffer of reference pictures, called decoded picture buffer (DPB), each reference picture being a picture reconstructed before the current picture.

In recent video compression methods, a current picture is generally associated to two lists of reference pictures pointing on pictures stored in the DPB. Each list is coded as high-level syntax, for instance, at a sequence level in a sequence parameter set (SPS), at a picture level in a picture header (PH) or at a slice level in a slice header (SH). The lists provide a status of each picture stored in the DPB which allows a decoder to manage the DPB by removing useless pictures from the DPB.

The coding of lists of reference pictures has a non-negligible cost in terms of bitrate which adversely affects compression efficiency.

It is desirable to propose solutions allowing to overcome the above issue. In particular, it is desirable to propose a solution reducing the bitrate cost of lists of reference pictures.

### 4. BRIEF SUMMARY

In a first aspect, one or more of the present embodiments provide a method comprising: determining an information allowing obtaining a picture order count difference between a picture order count of a current reference picture of a list of reference pictures associated to a current picture and a picture order count of the current picture; signaling said information in video data in data representative of the list of reference pictures; wherein: the determining of the information is based at least on a temporal identifier of the current picture.

In an embodiment, the determining of the picture order count difference is further based on a highest temporal identifier value in a group of picture's structure comprising the current picture.

In an embodiment, reference pictures of the list of reference pictures having a temporal identifier higher than the temporal identifier of the current picture are skipped for the determining of the information.

In an embodiment, the determining of the information is further based on at least one of a status of reference pictures of the list of reference pictures among a plurality of statuses comprising a status indicating that a reference picture concerned by this status is unused for reference and a layer identifier of reference pictures of the list of reference pictures.

In an embodiment, the reference pictures of the list of reference pictures having the status unused for reference or a layer identifier different from the layer identifier of the current picture are also skipped for the determining of the information.

In a second aspect, one or more of the present embodiments provide a method comprising: obtaining from video data an information allowing determining a picture order count difference between a picture order count of a current reference picture of a list of reference pictures associated to a current picture and a picture order count of the current picture; determining the picture order count difference from the information; and, determining a picture order count of the current reference picture from the picture order count difference; wherein, the determining of the picture order count difference from the information is based at least on a temporal identifier of the current picture.

In an embodiment, the determining of the picture order count difference is further based on a highest temporal identifier value in a group of picture's structure to which belongs the current picture.

In an embodiment, the picture order count difference is determined from a number of reference pictures of the list of reference pictures having a temporal identifier higher than the temporal identifier of the current picture.

In an embodiment, the picture order count difference is further based on at least one of a status of reference pictures of the list of reference pictures among a plurality of statuses comprising a status indicating that a reference picture concerned by this status is unused for reference and a layer identifier of reference pictures of the list of reference pictures.

In an embodiment, the picture order count difference is further determined from a number of reference pictures of the list of reference pictures having the status unused for reference or a layer identifier different from the layer identifier of the current picture.

In a third aspect, one or more of the present embodiments provide a device comprising electronic circuitry configured for: determining an information allowing obtaining a picture order count difference between a picture order count of a current reference picture of a list of reference pictures associated to a current picture and a picture order count of the current picture; signaling said information in video data in data representative of the list of reference pictures; wherein: the determining of the information is based at least on a temporal identifier of the current picture.

In an embodiment, the determining of the picture order count difference is further based on a highest temporal identifier value in a group of picture's structure comprising the current picture.

In an embodiment, reference pictures of the list of reference pictures having a temporal identifier higher than the temporal identifier of the current picture are skipped for the determining of the information.

In an embodiment, the determining of the information is further based on at least one of a status of reference pictures of the list of reference pictures among a plurality of statuses comprising a status indicating that a reference picture concerned by this status is unused for reference and a layer identifier of reference pictures of the list of reference pictures.

In an embodiment, the reference pictures of the list of reference pictures having the status unused for reference or a layer identifier different from the layer identifier of the current picture are also skipped for the determining of the information.

In a fourth aspect, one or more of the present embodiments provide a device comprising electronic circuitry configured for: obtaining from video data an information allowing determining a picture order count difference between a picture order count of a current reference picture of a list of reference pictures associated to a current picture and a picture order count of the current picture; determining the picture order count difference from the information; and, determining a picture order count of the current reference picture from the picture order count difference; wherein, the determining of the picture order count difference from the information is based at least on a temporal identifier of the current picture.

In an embodiment, the determining of the picture order count difference is further based a highest temporal identifier value in a group of picture's structure to which belongs the current picture.

In an embodiment, the picture order count difference is determined from a number of reference pictures of the list of reference pictures having a temporal identifier higher than the temporal identifier of the current picture.

In an embodiment, the picture order count difference is further based on at least one of a status of reference pictures of the list of reference pictures among a plurality of statuses comprising a status indicating that a reference picture concerned by this status is unused for reference and a layer identifier of reference pictures of the list of reference pictures.

In an embodiment, the picture order count difference is further determined from a number of reference pictures of the list of reference pictures having the status unused for reference or a layer identifier different from the layer identifier of the current picture.

In a fifth aspect, one or more of the present embodiments provide a non-transitory information storage medium storing program code instructions for implementing the method according to the first or the second aspect.

In a sixth aspect, one or more of the present embodiments provide a computer program comprising program code instructions for implementing the method according to the first or the second aspect.

In a seventh aspect, one or more of the present embodiments provide a signal generated by the method of the first aspect or by the device the third aspect.

### 5. BRIEF SUMMARY OF THE DRAWINGS

FIG. 1 illustrates schematically a context in which embodiments are implemented;

FIG. 2 illustrates schematically an example of partitioning undergone by a picture of pixels of an original video;

FIG. 3 depicts schematically a method for encoding a video stream;

FIG. 4 depicts schematically a method for decoding an encoded video stream;

FIG. 5A illustrates schematically an example of hardware architecture of a processing module able to implement an encoding module or a decoding module in which various aspects and embodiments are implemented;

FIG. 5B illustrates a block diagram of an example of a first system in which various aspects and embodiments are implemented;

FIG. 5C illustrates a block diagram of an example of a second system in which various aspects and embodiments are implemented;

FIG. 6A represents an example of temporal prediction structure of a group of pictures;

FIG. 6B represents an example of pictures kept in the DPB when encoding a current picture;

FIG. 7A illustrates a first embodiment of a method for signaling picture order count values implemented by an encoding module;

FIG. 7B illustrates a first embodiment of a method for signaling picture order count values implemented by a decoding module;

FIG. 8A represents schematically a DPB management process executed by an encoding module;

FIG. 8B represents schematically a DPB management process executed by an decoding module;

FIG. 9 illustrates an example of marking process for updating a status of pictures of the DPB;

FIG. 10 illustrates schematically a marking process for updating the status of pictures of the DPB using a temporal identifier;

FIG. 11 illustrates a first example of a reference picture index decoding process;

FIG. 12 illustrates a second example of a reference picture index decoding process; and,

FIG. 13 illustrates an example of a reference picture index encoding process.

### 6. DETAILED DESCRIPTION

The following examples of embodiments are described in the context of a video format similar to VVC (Versatile Video Coding (VVC) developed by a joint collaborative team of ITU-T and ISO/IEC experts known as the Joint Video Experts Team (JVET)). However, these embodiments are not limited to the video coding/decoding method corresponding to VVC. These embodiments are in particular adapted to various video formats comprising for example HEVC (ISO/IEC 23008-2-MPEG-H Part 2, High Efficiency Video Coding/ITU-T H.265)), AVC ((ISO/CEI 14496-10), EVC (Essential Video Coding/MPEG-5), AV1, AV2 and VP9.

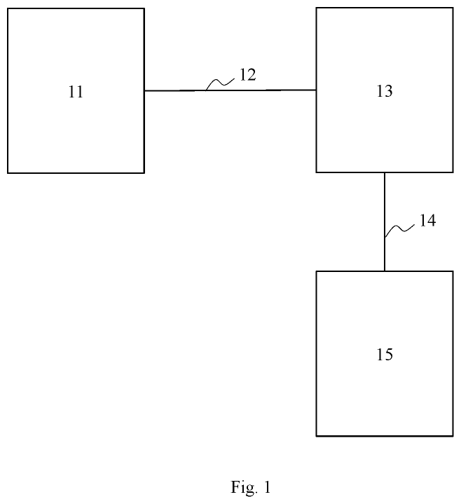

FIG. 1 illustrates schematically a context in which embodiments are implemented.

In FIG. 1, a system 11, that could be a camera, a storage device, a computer, a server or any device capable of delivering a video stream, transmits a video stream to a system 13 using a communication channel 12. The video stream is either encoded and transmitted by the system 11 or received and/or stored by the system 11 and then transmitted. The communication channel 12 is a wired (for example Internet or Ethernet) or a wireless (for example WiFi, 3G, 4G or 5G) network link.

The system 13, that could be for example a set top box, receives and decodes the video stream to generate a sequence of reconstructed pictures.

The obtained sequence of reconstructed pictures is then transmitted to a display system 15 using a communication channel 14, that could be a wired or wireless network. The display system 15 then displays said pictures.

In an embodiment, the system 13 is comprised in the display system 15. In that case, the system 13 and display system 15 are comprised in a TV, a computer, a tablet, a smartphone, a head-mounted display, etc.

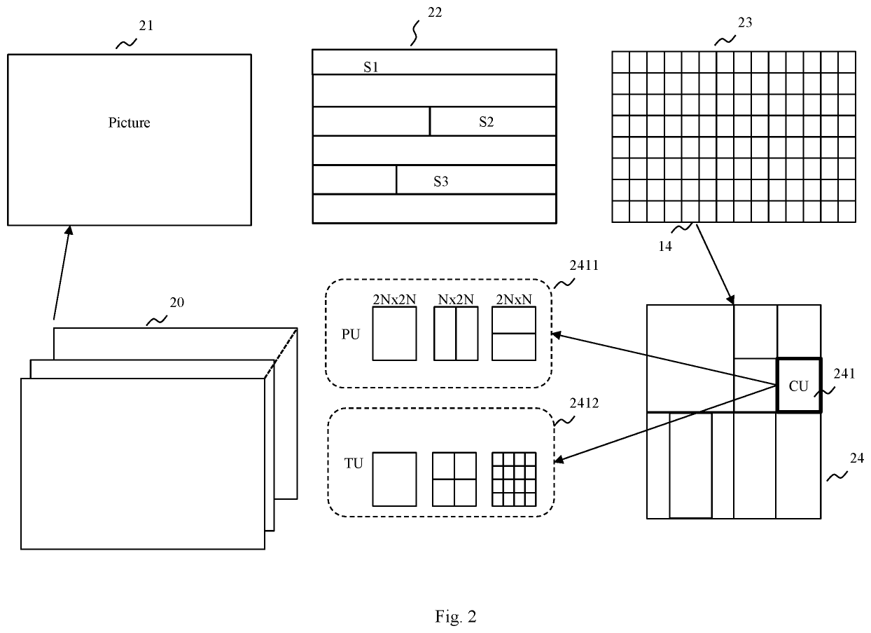

FIGS. 2, 3 and 4 introduce an example of video format.

FIG. 2 illustrates an example of partitioning undergone by a picture of pixels 21 of an original video sequence 20. It is considered here that a pixel is composed of three components: a luminance component and two chrominance components. Other types of pixels are however possible comprising less or more components such as only a luminance component or an additional depth component or transparency component.

A picture is divided into a plurality of coding entities. First, as represented by reference 23 in FIG. 2, a picture is divided in a grid of blocks called coding tree units (CTU). A CTU consists of an N×N block of luminance samples together with two corresponding blocks of chrominance samples. Nis generally a power of two having a maximum value of “128” for example. Second, a picture is divided into one or more groups of CTU. For example, it can be divided into one or more tile rows and tile columns, a tile being a sequence of CTU covering a rectangular region of a picture. In some cases, a tile could be divided into one or more bricks, each of which consisting of at least one row of CTU within the tile. Above the concept of tiles and bricks, another encoding entity, called slice, exists, that can contain at least one tile of a picture or at least one brick of a tile.

In the example in FIG. 2, as represented by reference 22, the picture 21 is divided into three slices S1, S2 and S3 of the raster-scan slice mode, each comprising a plurality of tiles (not represented), each tile comprising only one brick.

As represented by reference 24 in FIG. 2, a CTU may be partitioned into the form of a hierarchical tree of one or more sub-blocks called coding units (CU). The CTU is the root (i.e. the parent node) of the hierarchical tree and can be partitioned in a plurality of CU (i.e. child nodes). Each CU becomes a leaf of the hierarchical tree if it is not further partitioned in smaller CU or becomes a parent node of smaller CU (i.e. child nodes) if it is further partitioned.

In the example of FIG. 2, the CTU 24 is first partitioned in “4” square CU using a quadtree type partitioning. The upper left CU is a leaf of the hierarchical tree since it is not further partitioned, i.e. it is not a parent node of any other CU. The upper right CU is further partitioned in “4” smaller square CU using again a quadtree type partitioning. The bottom right CU is vertically partitioned in “2” rectangular CU using a binary tree type partitioning. The bottom left CU is vertically partitioned in “3” rectangular CU using a ternary tree type partitioning.

During the coding of a picture, the partitioning is adaptive, each CTU being partitioned so as to optimize a compression efficiency of the CTU criterion.

In HEVC appeared the concept of prediction unit (PU) and transform unit (TU). Indeed, in HEVC, the coding entity that is used for prediction (i.e. a PU) and transform (i.e. a TU) can be a subdivision of a CU. For example, as represented in FIG. 2, a CU of size 2N×2N, can be divided in PU 2411 of size N×2N or of size 2N×N. In addition, said CU can be divided in “4” TU 2412 of size N×N or in “16” TU of size (z/2)×(z/2).

One can note that in VVC, except in some particular cases, frontiers of the TU and PU are aligned on the frontiers of the CU. Consequently, a CU comprises generally one TU and one PU.

In the present application, the term “block” or “picture block” can be used to refer to any one of a CTU, a CU, a PU and a TU. In addition, the term “block” or “picture block” can be used to refer to a macroblock, a partition and a sub-block as specified in H.264/AVC or in other video coding standards, and more generally to refer to an array of samples of numerous sizes.

In the present application, the terms “reconstructed” and “decoded” may be used interchangeably, the terms “pixel” and “sample” may be used interchangeably, the terms “image,” “picture”, “sub-picture”, “slice” and “frame” may be used interchangeably. Usually, but not necessarily, the term “reconstructed” is used at the encoder side while “decoded” is used at the decoder side.

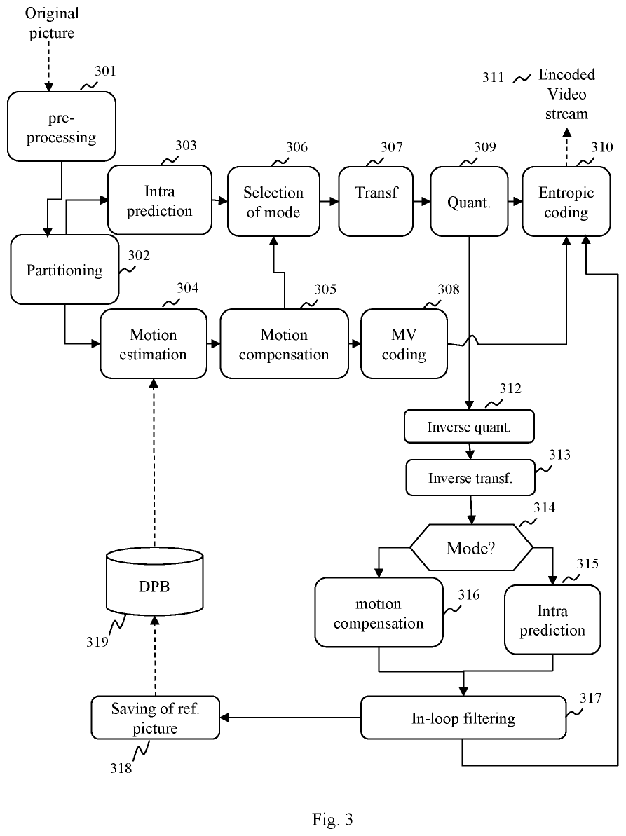

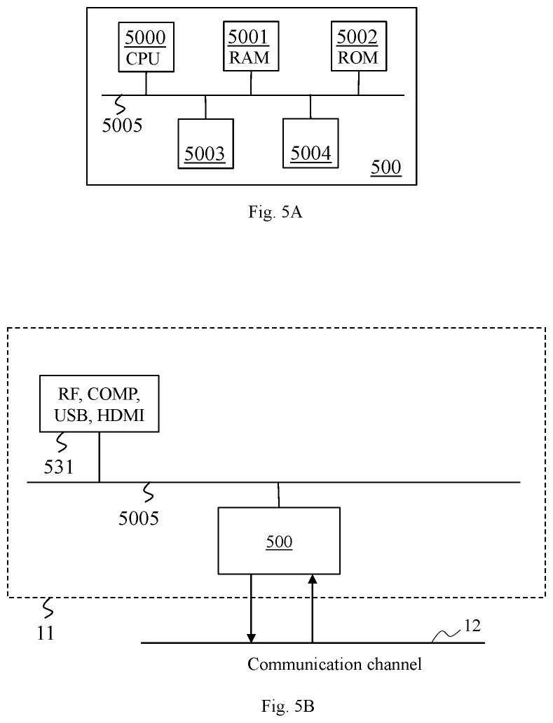

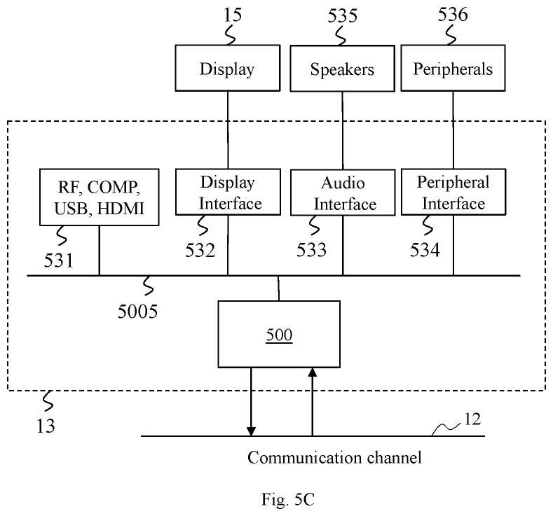

FIG. 3 depicts schematically a method for encoding a video stream executed by an encoding module. For instance, the method for encoding of FIG. 3 is executed by a processing module of the system 11. The processing module corresponds to a processing module 500 detailed in the following in relation to FIG. 5A. Variations of this method for encoding are contemplated, but the method for encoding of FIG. 3 is described below for purposes of clarity without describing all expected variations.

Before being encoded, a current original picture of an original video sequence may go through a pre-processing. For example, in a pre-processing step 301, a film grain analysis is applied to the original pictures.

Pictures outputted by the pre-processing step 301 are called pre-processed pictures in the following.

The encoding of a pre-processed picture begins with a partitioning of the pre-processed picture during a step 302, as described in relation to FIG. 2. The pre-processed picture is thus partitioned into CTU, CU, PU, TU, etc.

For each block, the encoding module determines then a coding mode between an intra prediction and an inter prediction.

The intra prediction consists of predicting, in accordance with an intra prediction method, during a step 303, the pixels of a current block from a prediction block derived from pixels of reconstructed blocks situated in a causal vicinity of the current block to be coded. The result of the intra prediction is a prediction direction indicating which pixels of the blocks in the vicinity to use, and a residual block resulting from a calculation of a difference between the current block and the prediction block.

The basic concept of inter prediction consists in predicting the pixels of a current block from an area of pixels, referred to as the reference block (or reference area), of a picture preceding or following the current picture. A picture comprising a reference block is referred to as a reference picture. During the coding of a current block in accordance with the inter prediction method, a block of a reference picture closest, in accordance with a similarity criterion, to the current block is determined by a motion estimation step 304. During step 304, a motion vector indicating the position of the reference block in the reference picture is determined. Said motion vector is used during a motion compensation step 305 during which a residual block is calculated in the form of a difference between the current block and the reference block. In first video compression standards, the mono-directional inter prediction mode described above was the only inter mode available. As video compression standards evolve, the family of inter modes has grown significantly and comprises now many different inter modes. In particular, a current block can be predicted from two reference blocks using a bi-prediction mode or B mode.

During a selection step 306, the prediction mode optimising the compression performances, in accordance with a rate/distortion optimization criterion (i.e. RDO criterion), among the prediction modes tested (Intra prediction modes, Inter prediction modes), is selected by the encoding module.

When the prediction mode is selected, the residual block is transformed during a step 307. The transformed block is then quantized during a step 309.

Note that the encoding module can skip the transform and apply quantization directly to the non-transformed residual signal.

When the current block is coded according to an intra prediction mode, a prediction direction and the transformed and quantized residual block are encoded by an entropic encoder during a step 310. When the current block is encoded according to an inter prediction, when appropriate, a motion vector of the block is predicted from a prediction vector selected from a set of motion vector predictors derived from reconstructed blocks situated in a spatial and temporal vicinity of the block to be encoded. The motion information is next encoded by the entropic encoder during step 310 in the form of a motion residual and an index for identifying the prediction vector.

The transformed and quantized residual block is encoded by the entropic encoder during step 310.

Note that the encoding module can bypass both transform and quantization, i.e., the entropic encoding is applied on the residual without the application of the transform or quantization processes. The result of the entropic encoding is inserted in an encoded video stream 311.

Metadata such as SEI (supplemental enhancement information) messages can be attached to the encoded video stream 311. A SEI message as defined for example in standards such as AVC, HEVC or VVC (or in standard Versatile supplemental enhancement information (VSEI) messages for coded video bitstreams—H.274) is a data container or a syntax structure associated to a video stream and comprising metadata providing information relative to the video stream.

After the quantization step 309, the current block is reconstructed so that the pixels corresponding to that block can be used for future predictions. This reconstruction phase is also referred to as a prediction loop. An inverse quantization is therefore applied to the transformed and quantized residual block during a step 312 and an inverse transformation is applied during a step 313. According to the prediction mode used for the block obtained during a step 314, the prediction block of the block is reconstructed. If the current block is encoded according to an inter prediction mode, the encoding module applies, when appropriate, during a step 316, a motion compensation using the motion vector of the current block in order to identify the reference block of the current block. If the current block is encoded according to an intra prediction mode, during a step 315, the prediction direction corresponding to the current block is used for reconstructing the prediction block of the current block. The prediction block and the reconstructed residual block (if any) are added in order to obtain the reconstructed current block.

Following the reconstruction, an in-loop filtering intended to reduce the encoding artefacts is applied, during a step 317, to the reconstructed block. This filtering is called in-loop filtering since this filtering occurs in the prediction loop to obtain at the decoder the same reference pictures as the encoder and thus avoid a drift between the encoding and the decoding processes. In-loop filtering tools comprises deblocking filtering, SAO (Sample adaptive Offset) and ALF (Adaptive Loop Filtering).

When a block is reconstructed, it is inserted during a step 318 into a reconstructed picture stored in a memory 319 of reconstructed pictures generally called Decoded Picture Buffer (DPB). The reconstructed pictures thus stored can then serve as reference pictures for other pictures to be coded.

The encoding process comprises a DPB management process applied for example before encoding each picture. The purpose of the DPB management process is to keep in the DPB only reconstructed pictures that are used as reference pictures for the current picture or that will be used as reference pictures for future pictures but not necessarily for the current picture. A picture present in the DPB that is not used as a prediction picture for the current picture or for a future picture is removed from the DPB.

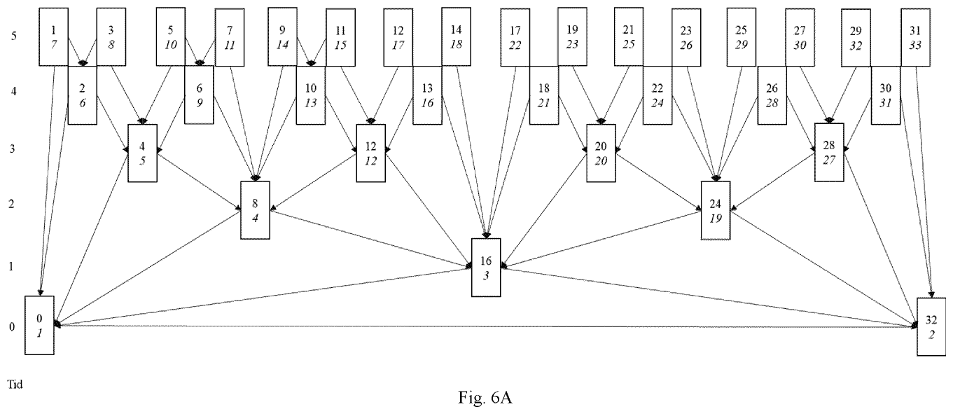

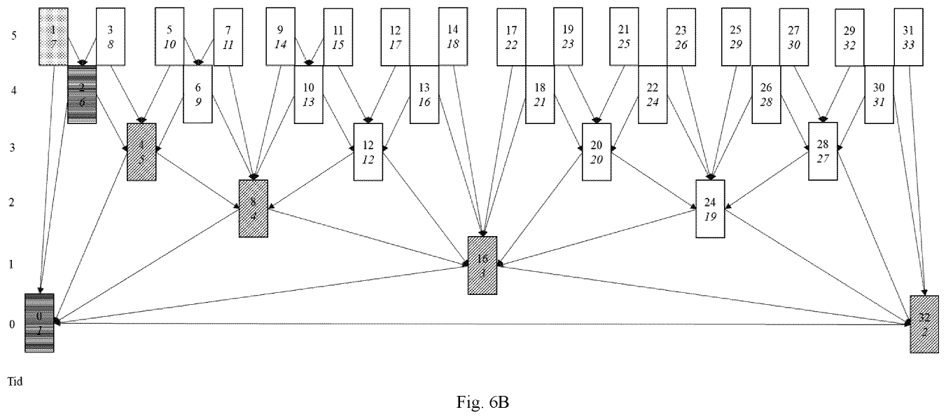

FIG. 6A represents an example of temporal prediction structure of a group of pictures.

The group of pictures (GOP) of FIG. 6A comprises “32” pictures. The top number associated to each picture represents a Picture Order Count (POC) corresponding to a display order of the picture. The bottom number associated to each picture (in italic) represents the picture number in encoding/decoding order. The arrows represent prediction dependencies between pictures. For instance, picture with POC=0 doesn't depend on any other picture. Picture with POC=0 is an INTRA picture. Picture with POC=32 depends on picture with POC=0. Picture with POC=16 depends on pictures with POC=0 and POC=32. In FIG. 6A, several temporal layers are represented. For example, it is considered that pictures with POC=0 and POC=32 corresponds to the lowest temporal layer, represented by a temporal identifier Tid=0. Picture with POC=16 corresponds to the temporal identifier Tid=1. Pictures with POC=8 and 24 corresponds to the temporal identifier Tid=2.

FIG. 6B represents an example of pictures kept in the DPB when encoding a current picture.

In FIG. 6B, picture with POC=1 is the current picture. Picture with POC=1 is predicted from picture with POC=0 and picture with POC=2. Therefore, only pictures with POC=0 and 2 are required to reconstruct the current picture. However, Pictures with POC=4, 8, 16 and 32 reconstructed before picture with POC=1 are needed for reconstructing pictures to be reconstructed after picture with POC=1. For instance, Picture with POC=4 is needed for reconstructing picture with POC=3. Consequently, at the beginning of the reconstruction of picture with POC=1, the DPB contains pictures with POC=1, 2, 4, 8, 16 and 32.

One role of the DPB management process is to generate lists of reference picture for each picture to be temporally predicted. In recent video compression methods, temporally predicted pictures could be associated to two lists to allow bi-prediction: list L0 and list L1. In each list, each reference picture is associated to a status. Four statuses are possible for a picture of a list of reference pictures: Short-term reference picture, long-term reference picture, inter-layer reference picture and Inactive reference picture. A short-term reference picture (STRP) is a picture that is close temporally to the current picture. A long-term reference picture (LTRP) is a picture that is temporally far from the current picture. An inter-layer reference picture (ILRP) is a picture with the same POC than the current picture but that belongs to a lower scalable layer. An inactive reference picture (IRP) is a picture that is not used for temporally predicting the current picture but that will be used as a reference picture for a future picture. A picture of the DPB having none of the above status is considered as an unused reference picture and is removed from the DPB by the DPB management process. List L0 and list L1 of reference pictures are signalled in the bitstream (i.e. in the video data) by high level syntax for instance, at a sequence level in a sequence parameter set (SPS), at a picture level in a picture header (PH) or at a slice level in a slice header (SH) to allow a decoder to manage the DPB the same way than the encoder.

An example of syntax allowing signaling list L0 and list L1 is given in table TAB1.

TABLE TAB1

```
ref_pic_list_struct( listIdx, rplsIdx ) {
  num_ref_entries[ listIdx ][ rplsIdx ]
  if( sps_long_term_ref_pics_flag && rplsIdx <
sps_num_ref_pic_lists[ listIdx ] &&
      num_ref_entries[ listIdx ][ rplsIdx ] > 0 )
    ltrp_in_header_flag[ listIdx ][ rplsIdx ]
  for( i = 0, j = 0; i < num_ref_entries[ listIdx ][ rplsIdx ]; i++) {
    if( sps_inter_layer_prediction_enabled_flag )
      inter_layer_ref_pic_flag[ listIdx ][ rplsIdx ][ i ]
    if( !inter_layer_ref_pic_flag[ listIdx ][ rplsIdx ][ i ] ) {
      if( sps_long_term_ref_pics_flag )
        st_ref_pic_flag[ listIdx ][ rplsIdx ][ i ]
      if( st_ref_pic_flag[ listIdx ][ rplsIdx ][ i ] ) {
        abs_delta_poc_st[ listIdx ][ rplsIdx ][ i ]
        if( AbsDeltaPocSt[ listIdx ][ rplsIdx ][ i ] > 0 )
          strp_entry_sign_flag[ listIdx ][ rplsIdx ][ i ]
      } else if( !ltrp_in_header_flag[ listIdx ][ rplsIdx ] )
        rpls_poc_lsb_lt[ listIdx ][ rplsIdx ][ j++ ]
    } else
      ilrp_idx[ listIdx ][ rplsIdx ][ i ]
  }
}
```

The signaling of the reference pictures uses variable length coding depending on POC difference values to signal reference pictures as defined in Table TAB1. If the POC difference is not null, the sign of the difference is signaled.

TABLE TAB2

| | | | L0 list | | | | | | | | | | | |
|---|---|---|---|---|---|---|---|---|---|---|---|---|---|---|
| Picture | | | active | total | | | | | | | | | | |
| coding | | | ref | ref | | | | | | | | | | |
| order | POC | Tid | number | number | reference POC offset (ref POC) | | | | | | | | | |
| intra | 0 | 0 | | | | | | | | | | | | |
| 1 | 32 | 0 | 1 | 1 | 32 | (0) | | | | | | | | |
| 2 | 16 | 1 | 1 | 5 | 16 | (0) | | | | | | | | |
| 3 | 8 | 2 | 1 | 5 | 8 | (0) | | | | | | | | |
| 4 | 4 | 3 | 1 | 3 | 4 | (0) | | | | | | | | |
| 5 | 2 | 4 | 1 | 3 | 2 | (0) | | | | | | | | |
| 6 | 1 | 5 | 1 | 1 | 1 | (0) | | | | | | | | |
| 7 | 3 | 5 | 2 | 2 | 1 | (2) | 3 | (0) | | | | | | |
| 8 | 6 | 4 | 3 | 3 | 2 | (4) | 4 | (2) | 6 | (0) | | | | |
| 9 | 5 | 5 | 2 | 2 | 1 | (4) | 5 | (0) | | | | | | |
| 10 | 7 | 5 | 2 | 3 | 1 | (6) | 3 | (4) | 7 | (0) | | | | |
| 11 | 12 | 3 | 3 | 4 | 4 | (8) | 8 | (4) | 12 | (0) | 6 | (6) | | |
| 12 | 10 | 4 | 4 | 4 | 2 | (8) | 4 | (6) | 6 | (4) | 10 | (0) | | |
| 13 | 9 | 5 | 2 | 3 | 1 | (8) | 5 | (4) | 9 | (0) | | | | |
| 14 | 11 | 5 | 2 | 3 | 1 | (10) | 3 | (8) | 11 | (0) | | | | |
| 15 | 14 | 4 | 4 | 4 | 2 | (12) | 4 | (10) | 6 | (8) | 14 | (0) | | |
| 16 | 13 | 5 | 2 | 3 | 1 | (12) | 5 | (8) | 13 | (0) | | | | |
| 17 | 15 | 5 | 2 | 4 | 1 | (14) | 3 | (12) | 7 | (8) | 15 | (0) | | |
| 18 | 24 | 2 | 3 | 3 | 8 | (16) | 16 | (8) | 24 | (0) | | | | |
| 19 | 20 | 3 | 3 | 3 | 4 | (16) | 12 | (8) | 20 | (0) | | | | |
| 20 | 18 | 4 | 3 | 3 | 2 | (16) | 10 | (8) | 18 | (0) | | | | |
| 21 | 17 | 5 | 2 | 3 | 1 | (16) | 9 | (8) | 17 | (0) | | | | |
| 22 | 19 | 5 | 2 | 3 | 1 | (18) | 3 | (16) | 19 | (0) | | | | |
| 23 | 22 | 4 | 3 | 3 | 2 | (20) | 6 | (16) | 22 | (0) | | | | |
| 24 | 21 | 5 | 2 | 3 | 1 | (20) | 5 | (16) | 21 | (0) | | | | |
| 25 | 23 | 5 | 2 | 4 | 1 | (22) | 3 | (20) | 7 | (16) | 23 | (0) | | |
| 26 | 28 | 3 | 4 | 4 | 4 | (24) | 8 | (20) | 12 | (16 | 28 | (0) | | |
| 27 | 26 | 4 | 4 | 4 | 2 | (24) | 6 | (20) | 10 | (16 | 26 | (0) | | |
| 28 | 25 | 5 | 2 | 4 | 1 | (24) | 5 | (20) | 9 | (16) | 25 | (0) | | |
| 29 | 27 | 5 | 2 | 4 | 1 | (26) | 3 | (24) | 11 | (16 | 27 | (0) | | |
| 30 | 30 | 4 | 4 | 4 | 2 | (28) | 6 | (24) | 14 | (16 | 30 | (0) | | |
| 31 | 29 | 5 | 2 | 4 | 1 | (28) | 5 | (24) | 13 | (16 | 29 | (0) | | |
| 32 | 31 | 5 | 2 | 5 | 1 | (30) | 3 | (28) | 7 | (24) | 15 | (16 | 31 | (0) |
| 33 | 64 | 0 | 2 | 5 | 32 | (32 | 64 | (0) | 48 | (16 | 40 | (24 | 36 | (28) |
| 34 | 48 | 1 | 3 | 5 | 16 | (32 | 32 | (16 | 48 | (0) | 24 | (24 | 20 | (28) |
| 35 | 40 | 2 | 4 | 5 | 8 | (32) | 24 | (16 | 16 | (24 | 40 | (0) | 12 | (28) |
| 36 | 36 | 3 | 3 | 3 | 4 | (32) | 8 | (28) | 20 | (16 | | | | |
| 37 | 34 | 4 | 3 | 3 | 2 | (32) | 6 | (28) | 18 | (16 | | | | |

| | L1 list | | | | | | | | | |
|---|---|---|---|---|---|---|---|---|---|---|
| Picture | active | total | | | | | | | | |
| coding | ref | ref | | | | | | | | |
| order | number | number | reference POC offset (ref POC) | | | | | | | |
| intra | | | | | | | | | | |
| 1 | 1 | 1 | 32 | (0) | | | | | | |
| 2 | 1 | 1 | −16 | (32) | | | | | | |
| 3 | 2 | 2 | −8 | (16) | −24 | (32) | | | | |
| 4 | 3 | 3 | −4 | (8) | −12 | (16) | −28 | (32) | | |
| 5 | 4 | 4 | −2 | (4) | −6 | (8) | −14 | (16) | −30 (32) | |
| 6 | 2 | 5 | −1 | (2) | −3 | (4) | −7 | (8) | −15 (16) | −31 (32) |
| 7 | 2 | 4 | −1 | (4) | −5 | (8) | −13 | (16) | −29 (32) | |
| 8 | 3 | 3 | −2 | (8) | −10 | (16) | −26 | (32) | | |
| 9 | 2 | 4 | −1 | (6) | −3 | (8) | −11 | (16) | −27 (32) | |
| 10 | 2 | 3 | −1 | (8) | −9 | (16) | −25 | (32) | | |
| 11 | 2 | 2 | −4 | (16) | −20 | (32) | | | | |
| 12 | 3 | 3 | −2 | (12) | −6 | (16) | −22 | (32) | | |
| 13 | 2 | 4 | −1 | (10) | −3 | (12) | −7 | (16) | −23 (32) | |
| 14 | 2 | 3 | −1 | (12) | −5 | (16) | −21 | (32) | | |
| 15 | 2 | 2 | −2 | (16) | −18 | (32) | | | | |
| 16 | 2 | 3 | −1 | (14) | −3 | (16) | −19 | (32) | | |
| 17 | 2 | 2 | −1 | (16) | −17 | (32) | | | | |
| 18 | 1 | 1 | −8 | (32) | | | | | | |
| 19 | 2 | 2 | −4 | (24) | −12 | (32) | | | | |
| 20 | 3 | 3 | −2 | (20) | −6 | (24) | −14 | (32) | | |
| 21 | 2 | 4 | −1 | (18) | −3 | (20) | −7 | (24) | −15 (32) | |
| 22 | 2 | 3 | −1 | (20) | −5 | (24) | −13 | (32) | | |
| 23 | 3 | 3 | −2 | (24) | −10 | (32) | 4 | (18) | | |
| 24 | 2 | 3 | −1 | (22) | −3 | (24) | −11 | (32) | | |
| 25 | 2 | 2 | −1 | (24) | −9 | (32) | | | | |
| 26 | 1 | 1 | −4 | (32) | | | | | | |
| 27 | 2 | 2 | −2 | (28) | −6 | (32) | | | | |
| 28 | 2 | 3 | −1 | (26) | −3 | (28) | −7 | (32) | | |
| 29 | 2 | 2 | −1 | (28) | −5 | (32) | | | | |
| 30 | 1 | 1 | −2 | (32) | | | | | | |
| 31 | 2 | 2 | −1 | (30) | −3 | (32) | | | | |
| 32 | 1 | 1 | −1 | (32) | | | | | | |
| 33 | 1 | 2 | 32 | (32) | 48 | (16) | | | | |
| 34 | 1 | 1 | −16 | (64) | | | | | | |
| 35 | 2 | 2 | −8 | (48) | −24 | (64) | | | | |
| 36 | 3 | 3 | −4 | (40) | −12 | (48) | −28 | (64) | | |
| 37 | 4 | 4 | −2 | (36) | −6 | (40) | −14 | (48) | −30 (64) | |

Table TAB2 represents for each picture of an exemplary GOP of size 32, an example of the content of list L0 and list L1 as encoded using the syntax of table TAB1. A first column of table TAB2 represents the picture coding order of each “current” picture for which a list L0 and a list L1 is given. A second column of table TAB2 represents the POC of each “current” picture. A third column of table TAB2 represents the temporal identifier Tid of each “current picture” picture. A fourth column of table TAB2 represents the content of list L0. A fifth column of table TAB2 represents the content of list L1. For each list (L0 and L1), table TAB1 provides for each “current” picture, a number of active reference pictures in the list representing the number of pictures that are either STRP, LTRP or ILRP in the list of reference pictures and a total number of pictures representing the number of pictures that are either STRP, LTRP, ILRP or IRP in the list of reference pictures. As can be seen, a reference picture of the list is identified by a POC difference value (difference between its POC and the POC of the current picture (i.e. the reference POC offset in table TAB2)). In table TAB2, reference POC offsets in bold represent reference pictures having the status IRP.

In table TAB1, the syntax element abs_delta_poc_st[listIdx][rplsIdx][i] specifies a value of a variable AbsDeltaPocSt[listIdx][rplsIdx][i] as follows:

```
  if( ( sps_{—}weighted_{—}pred_{—}flag || sps_{—}weighted_{—}bipred_{—}flag ) &&
i != 0 )
    AbsDeltaPocSt[ listIdx ][ rplsIdx ][ i ] = abs_{—}delta_{—}poc_{—}st[
  listIdx ][ rplsIdx ][ i ]
  else
    AbsDeltaPocSt[ listIdx ][ rplsIdx ][ i ] = abs_{—}delta_{—}poc_{—}st[
  listIdx ][ rplsIdx ][ i ] + 1
```

The syntax elements sps weighted_predflag sps weighted bipred flag are sequence level (sequence parameter set level) indicating respectively if weighted prediction and bidirectional weighted prediction are allowed for a current sequence.

The value of abs_delta_poc_st[listIdx][rplsIdx][i] shall be in a range of “0” to “2¹⁵−1”, inclusive.

strp_entry_sign_flag[listIdx][rplsIdx][i] equal to “0” specifies that DeltaPocValSt [listIdx][rplsIdx] is greater than or equal to “0”. strp_entry_sign_flag[listIdx][rplsIdx][i] equal to “1” specifies that DeltaPocValSt[listIdx][rplsIdx] is less than “0”. When not present, the value of strp_entry_sign_flag[listIdx][rplsIdx][i] is inferred to be equal to “0”.

A list ofDeltaPocValSt[listIdx][rplsIdx] is derived as follows:

$$for ( i = 0 ; i < num\_ref \_entries [ listIdx ] [ rplsIdx ] ; i ++ )$$

$$if ( ! inter\_layer \_ref \_pic \_flag [ listIdx ] [ rplsIdx ] [ i ] \&\& st\_ref \_pic \_flag [ listIdx ] [ i ] ) DeltaPocValSt [ listIdx ] [ rplsIdx ] [ i ] = ( 1 - 2 * strp\_entry \_sign \_flag [ listIdx ] [ rplsIdx ] [ i ] ) * AbsDeltaPocSt [ listIdx ] [ rplsIdx ] [ i ]$$

DeltaPocValSt is then used to derive the POC difference (i.e. reference POC offsets) with the current picture incrementally: the first reference picture POC difference is coded against the current picture, then they are coded against the previous reference picture.

With the functioning of the reference pictures in VVC, POC difference is coded without considering picture attributes. However, a picture having a given Temporal identifier Tid can only use reference pictures having a lower or equal temporal identifier Tid_ref. It is necessary to signal large POC differences. This results in a bitrate overhead to signal such pictures.

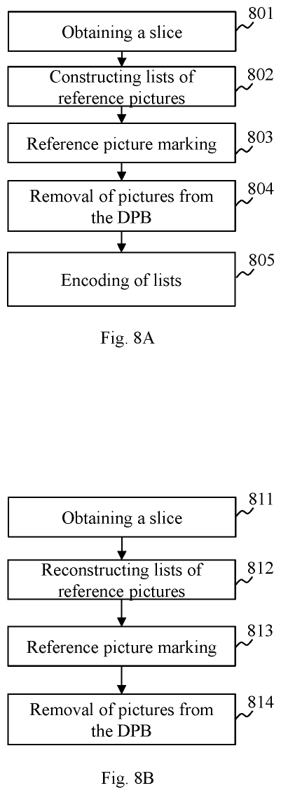

FIG. 8A represents schematically a DPB management process executed by an encoding module.

The process of FIG. 8A is executed by a processing module 500 of the system 11 when this processing module 500 implements an encoding module applying the method of encoding of FIG. 3. The process of FIG. 8A is invoked for each picture for instance before the encoding of the first slice of a current picture. In the process of FIG. 8A, the processing module 500 is supposed to know the GOP structure used for encoding the pictures of a sequence of pictures. Consequently, the processing module 500 knows exactly for each picture which reference picture is to be used and which picture must be kept in the DPB 319.

In a step 801, the processing module 500 obtains a first slice of a current picture.

In a step 802, the processing module 500 constructs at least one list of reference pictures for the current picture. In the example of FIG. 8A, the processing module constructs a list L0 and a list L1 for the current picture.

In a step 803, the processing module 500 applies a marking process to the pictures of the DPB based on the lists L0 and L1 to update a status of pictures of the DPB.

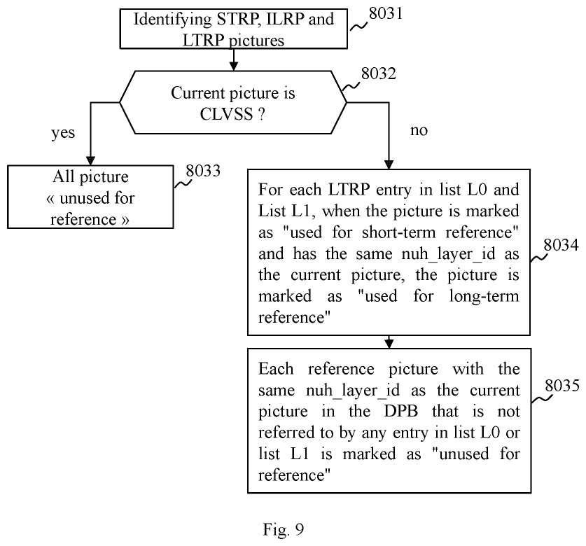

FIG. 9 illustrates an example of marking process for updating a status of pictures of the DPB.

The process of FIG. 9, when applied by the encoding module, is invoked once per picture (called “current picture”), prior the encoding of the slice data. This process might result in one or more reference pictures in the DPB 319 being marked as “unused for reference” picture (URP) or “used for long-term reference” picture (LTRP).

A decoded picture in the DPB 319 can be marked as URP, “used for short-term reference” picture (STRP) or LTRP, but only one among these three at any given moment during the operation of the decoding process. Assigning one of these markings to a picture implicitly removes another of these markings when applicable. When a picture is referred to as being marked as “used for reference”, this collectively refers to the picture being marked as STRP or LTRP (but not both).

In a step 8031, the processing module 500 identifies STRP, ILRP and LTRP pictures in the DPB 319. STRPs and ILRPs are identified by their nuh_layer_id (layer identifier) and PicOrderCntVal (POC) values. LTRPs are identified by their nuh_layer_id values and by the Log2(MaxPicOrderCntLsb) LSBs (Least Significant Bits) of their PicOrderCntVal (POC) values or their PicOrderCntVal (POC) values.

In a step 8032, the processing module 500 determines if the current picture is a CLVSS (coded layer video sequence start) picture.

If the current picture is a CLVSS picture, all reference pictures currently in the DPB 319 (if any) with the same nuh_layer_id as the current picture are marked by the processing module 500 as URP in a step 8033. Otherwise, step 8032 is followed by steps 8034 and 8035.

In step 8034, for each LTRP entry in RefPicList[0](i.e. in List L0) or RefPicList[1](i.e. in List L1), when the picture is marked as STRP and has the same nuh_layer_id as the current picture, the picture is marked as LTRP.

In step 8035, each reference picture with the same nuh_layer_id as the current picture in the DPB 319 that is not referred to by any entry in list L0 or list L1 is marked as URP.

In a step 804, the processing module 500 removes reference pictures marked as URP from the DPB 319. Step 804 could be optional but ensures that the DPB 319 contains the minimum number of reference pictures required for encoded the current and future pictures.

In a step 805, the processing module 500 encodes the lists of reference pictures L0 and L1 (with the status of each picture of the lists determined by the marking process of step 803) in the video data, for instance in the slice header of the first slice of the current picture.

The DPB management process of FIG. 8A is followed by an actual encoding of the picture data of the first slice of the current picture.

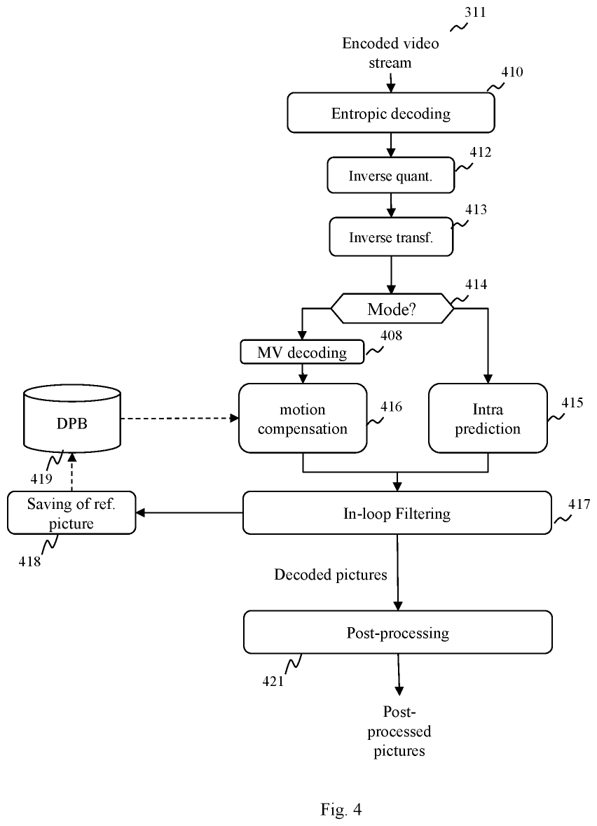

FIG. 4 depicts schematically a method for decoding the encoded video stream 311 encoded according to method described in relation to FIG. 3 executed by a decoding module. For instance, the method for decoding of FIG. 4 is executed by a processing module 500 of the system 13. Variations of this method for decoding are contemplated, but the method for decoding of FIG. 4 is described below for purposes of clarity without describing all expected variations.

Before starting the decoding of the picture data, the processing module 500 reconstructs lists of reference pictures and manages the DPB 419 so that it is identical to the DPB 319 when starting the encoding of the same current picture.

FIG. 8B represents schematically a DPB management process executed by a decoding module.

The process of FIG. 8B is executed by a processing module 500 of the system 13 when this processing module 500 implements a decoding module applying the method of decoding of FIG. 4. The process of FIG. 8B is invoked for each picture for instance before the decoding of the first slice of a current picture.

In a step 811, the processing module 500 obtains video data representing the first slice of the current picture.

In a step 812, the processing module 500 reconstructs at least one list of reference pictures for the current picture, each list representing reference pictures stored in the DPB 419. Again, we suppose here that the processing module 500 reconstructs a list L0 and a list L1 of reference pictures. The reconstruction of lists L0 and L1 uses information representative of these lists decoded from (i.e. signaled in) the video data, for instance, in the SPS, picture header or slice header using the syntax of table TAB1.

In a step 813, the processing module 500 applies a marking process to update the status of the reference pictures stored in the DPB using the information representative of the lists signalled in the video data. To do so, the processing module 500 applies the process of FIG. 9. The process of FIG. 9, when applied by the decoding module, is invoked once per picture, prior the decoding of the slice data, and concerns reference pictures stored in the DPB 419.

In a step 814, the processing module 500 removes reference pictures marked as URP from the DPB 419.

The decoding of picture data is then done block by block. For a current block, it starts with an entropic decoding of the CTU comprising the current block (to determine the partitioning of the CTU) and then the entropy decoding of information representative the current block during a step 410. Entropic decoding allows to obtain, at least, the prediction mode of the block.

If the block has been encoded according to an inter prediction mode, the entropic decoding allows to obtain, when appropriate, a prediction vector index, a motion residual and a residual block (if any). During a step 408, a motion vector is reconstructed for the current block using the prediction vector index and the motion residual.

If the block has been encoded according to an intra prediction mode, entropic decoding allows to obtain a prediction direction and a residual block (if any). Steps 412, 413, 414, 415, 416 and 417 implemented by the decoding module are in all respects identical respectively to steps 312, 313, 314, 315, 316 and 317 implemented by the encoding module. One can note that the motion compensation step 416 uses list L0 and list L1 to retrieve reference pictures from the DPB 419. Decoded blocks are saved in decoded pictures and the decoded pictures are stored in a DPB 419 in a step 418.

The decoded picture can also be outputted by the decoding module for instance to be displayed.

FIGS. 5A, 5B and 5C describe examples of devices, apparatus and/or systems allowing implementing various embodiments.

FIG. 5A illustrates schematically an example of hardware architecture of a processing module 500 able to implement an encoding module or a decoding module capable of implementing respectively a method for encoding of FIG. 3 and a method for decoding of FIG. 4 modified according to different aspects and embodiments. The encoding module is for example comprised in the system 11 when this system is in charge of encoding the video stream. The decoding module is for example comprised in the system 13.

The processing module 500 comprises, connected by a communication bus 5005: a processor or CPU (central processing unit) 5000 encompassing one or more microprocessors, general purpose computers, special purpose computers, and processors based on a multi-core architecture, as non-limiting examples; a random access memory (RAM) 5001; a read only memory (ROM) 5002; a storage unit 5003, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive, or a storage medium reader, such as a SD (secure digital) card reader and/or a hard disc drive (HDD) and/or a network accessible storage device; at least one communication interface 5004 for exchanging data with other modules, devices or system. The communication interface 5004 can include, but is not limited to, a transceiver configured to transmit and to receive data over a communication channel. The communication interface 5004 can include, but is not limited to, a modem or network card.

If the processing module 500 implements a decoding module, the communication interface 5004 enables for instance the processing module 500 to receive encoded video streams and to provide a sequence of decoded pictures. If the processing module 500 implements an encoding module, the communication interface 5004 enables for instance the processing module 500 to receive a sequence of original picture data to encode and to provide an encoded video stream.

The processor 5000 is capable of executing instructions loaded into the RAM 5001 from the ROM 5002, from an external memory (not shown), from a storage medium, or from a communication network. When the processing module 500 is powered up, the processor 5000 is capable of reading instructions from the RAM 5001 and executing them. These instructions form a computer program causing, for example, the implementation by the processor 5000 of a decoding method as described in relation with FIG. 4 and/or an encoding method described in relation to FIG. 3, and the methods illustrated in relation to FIGS. 8A, 8B, 9 and 10, these methods comprising various aspects and embodiments described below in this document.

All or some of the algorithms and steps of the methods of FIGS. 3, 4 and 8A, 8B, 9 and 10 may be implemented in software form by the execution of a set of instructions by a programmable machine such as a DSP (digital signal processor) or a microcontroller, or be implemented in hardware form by a machine or a dedicated component such as a FPGA (field-programmable gate array) or an ASIC (application-specific integrated circuit).

As can be seen, microprocessors, general purpose computers, special purpose computers, processors based or not on a multi-core architecture, DSP, microcontroller, FPGA and ASIC are electronic circuitry adapted or configured to implement at least partially the methods of FIGS. 3, 4 and 8A, 8B, 9 and 10.

FIG. 5C illustrates a block diagram of an example of the system 13 in which various aspects and embodiments are implemented. The system 13 can be embodied as a device including the various components described below and is configured to perform one or more of the aspects and embodiments described in this document. Examples of such devices include, but are not limited to, various electronic devices such as personal computers, laptop computers, smartphones, tablet computers, digital multimedia set top boxes, digital television receivers, personal video recording systems, connected home appliances and head mounted display. Elements of system 13, singly or in combination, can be embodied in a single integrated circuit (IC), multiple ICs, and/or discrete components. For example, in at least one embodiment, the system 13 comprises one processing module 500 that implements a decoding module. In various embodiments, the system 13 is communicatively coupled to one or more other systems, or other electronic devices, via, for example, a communications bus or through dedicated input and/or output ports. In various embodiments, the system 13 is configured to implement one or more of the aspects described in this document.

The input to the processing module 500 can be provided through various input modules as indicated in block 531. Such input modules include, but are not limited to, (i) a radio frequency (RF) module that receives an RF signal transmitted, for example, over the air by a broadcaster, (ii) a component (COMP) input module (or a set of COMP input modules), (iii) a Universal Serial Bus (USB) input module, and/or (iv) a High Definition Multimedia Interface (HDMI) input module. Other examples, not shown in FIG. 5C, include composite video.

In various embodiments, the input modules of block 531 have associated respective input processing elements as known in the art. For example, the RF module can be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which can be referred to as a channel in certain embodiments, (iv) demodulating the down-converted and band-limited signal, (v) performing error correction, and (vi) demultiplexing to select the desired stream of data packets. The RF module of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. In one set-top box embodiment, the RF module and its associated input processing element receives an RF signal transmitted over a wired (for example, cable) medium, and performs frequency selection by filtering, down-converting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF module includes an antenna.

Additionally, the USB and/or HDMI modules can include respective interface processors for connecting system 13 to other electronic devices across USB and/or HDMI connections. It is to be understood that various aspects of input processing, for example, Reed-Solomon error correction, can be implemented, for example, within a separate input processing IC or within the processing module 500 as necessary.

Similarly, aspects of USB or HDMI interface processing can be implemented within separate interface ICs or within the processing module 500 as necessary. The demodulated, error corrected, and demultiplexed stream is provided to the processing module 500.

Various elements of system 13 can be provided within an integrated housing. Within the integrated housing, the various elements can be interconnected and transmit data therebetween using suitable connection arrangements, for example, an internal bus as known in the art, including the Inter-IC (I2C) bus, wiring, and printed circuit boards. For example, in the system 13, the processing module 500 is interconnected to other elements of said system 13 by the bus 5005.

The communication interface 5004 of the processing module 500 allows the system 13 to communicate on the communication channel 12. As already mentioned above, the communication channel 12 can be implemented, for example, within a wired and/or a wireless medium.

Data is streamed, or otherwise provided, to the system 13, in various embodiments, using a wireless network such as a Wi-Fi network, for example IEEE 802.11 (IEEE refers to the Institute of Electrical and Electronics Engineers). The Wi-Fi signal of these embodiments is received over the communications channel 12 and the communications interface 5004 which are adapted for Wi-Fi communications. The communications channel 12 of these embodiments is typically connected to an access point or router that provides access to external networks including the Internet for allowing streaming applications and other over-the-top communications. Other embodiments provide streamed data to the system 13 using the RF connection of the input block 531. As indicated above, various embodiments provide data in a non-streaming manner. Additionally, various embodiments use wireless networks other than Wi-Fi, for example a cellular network or a Bluetooth network.

The system 13 can provide an output signal to various output devices, including the display system 15, speakers 535, and other peripheral devices 536. The display system 15 of various embodiments includes one or more of, for example, a touchscreen display, an organic light-emitting diode (OLED) display, a curved display, and/or a foldable display. The display system 15 can be for a television, a tablet, a laptop, a cell phone (mobile phone), ahead mounted display or other devices. The display system 15 can also be integrated with other components (for example, as in a smart phone), or separate (for example, an external monitor for a laptop). The other peripheral devices 536 include, in various examples of embodiments, one or more of a stand-alone digital video disc (or digital versatile disc) (DVR, for both terms), a disk player, a stereo system, and/or a lighting system. Various embodiments use one or more peripheral devices 536 that provide a function based on the output of the system 13. For example, a disk player performs the function of playing an output of the system 13.

In various embodiments, control signals are communicated between the system 13 and the display system 15, speakers 535, or other peripheral devices 536 using signaling such as AV.Link, Consumer Electronics Control (CEC), or other communications protocols that enable device-to-device control with or without user intervention. The output devices can be communicatively coupled to system 13 via dedicated connections through respective interfaces 532, 533, and 534. Alternatively, the output devices can be connected to system 13 using the communications channel 12 via the communications interface 5004 or a dedicated communication channel corresponding to the communication channel 12 in FIG. 5C via the communication interface 5004. The display system 15 and speakers 535 can be integrated in a single unit with the other components of system 13 in an electronic device such as, for example, a television. In various embodiments, the display interface 532 includes a display driver, such as, for example, a timing controller (T Con) chip.

The display system 15 and speaker 535 can alternatively be separate from one or more of the other components. In various embodiments in which the display system and speakers 535 are external components, the output signal can be provided via dedicated output connections, including, for example, HDMI ports, USB ports, or COMP outputs.

FIG. 5B illustrates a block diagram of an example of the system 11 in which various aspects and embodiments are implemented. System 11 is very similar to system 13. The system 11 can be embodied as a device including the various components described below and is configured to perform one or more of the aspects and embodiments described in this document. Examples of such devices include, but are not limited to, various electronic devices such as personal computers, laptop computers, smartphones, tablet computers, a camera and a server. Elements of system 11, singly or in combination, can be embodied in a single integrated circuit (IC), multiple ICs, and/or discrete components. For example, in at least one embodiment, the system 11 comprises one processing module 500 that implements an encoding module. In various embodiments, the system 11 is communicatively coupled to one or more other systems, or other electronic devices, via, for example, a communications bus or through dedicated input and/or output ports. In various embodiments, the system 11 is configured to implement one or more of the aspects described in this document.

The input to the processing module 500 can be provided through various input modules as indicated in block 531 already described in relation to FIG. 5C.

Various elements of system 11 can be provided within an integrated housing. Within the integrated housing, the various elements can be interconnected and transmit data therebetween using suitable connection arrangements, for example, an internal bus as known in the art, including the Inter-IC (I2C) bus, wiring, and printed circuit boards. For example, in the system 11, the processing module 500 is interconnected to other elements of said system 11 by the bus 5005.

The communication interface 5004 of the processing module 500 allows the system 11 to communicate on the communication channel 12.

Data is streamed, or otherwise provided, to the system 11, in various embodiments, using a wireless network such as a Wi-Fi network, for example IEEE 802.11 (IEEE refers to the Institute of Electrical and Electronics Engineers). The Wi-Fi signal of these embodiments is received over the communications channel 12 and the communications interface 5004 which are adapted for Wi-Fi communications. The communications channel 12 of these embodiments is typically connected to an access point or router that provides access to external networks including the Internet for allowing streaming applications and other over-the-top communications. Other embodiments provide streamed data to the system 11 using the RF connection of the input block 531.

As indicated above, various embodiments provide data in a non-streaming manner. Additionally, various embodiments use wireless networks other than Wi-Fi, for example a cellular network or a Bluetooth network.

The data provided to the system 11 can be provided in different format. In various embodiments these data are encoded and compliant with a known video compression format such as AV1, VP9, VVC, HEVC, AVC, EVC, AV2 etc. In various embodiments, these data are raw data provided for example by a picture and/or audio acquisition module connected to the system 11 or comprised in the system 11. In that case, the processing module 500 takes in charge the encoding of these data.

The system 11 can provide an output signal to various output devices capable of storing and/or decoding the output signal such as the system 13.

Various implementations involve decoding. “Decoding”, as used in this application, can encompass all or part of the processes performed, for example, on a received encoded video stream in order to produce a final output suitable for display. In various embodiments, such processes include one or more of the processes typically performed by a decoder, for example, entropy decoding, inverse quantization, inverse transformation, and prediction. In various embodiments, such processes also, or alternatively, include processes performed by a decoder of various implementations described in this application, for example, for managing lists of reference pictures stored in a DPB.

Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded video stream. In various embodiments, such processes include one or more of the processes typically performed by an encoder, for example, partitioning, prediction, transformation, quantization, and entropy encoding. In various embodiments, such processes also, or alternatively, include processes performed by an encoder of various implementations described in this application, for example, for managing lists of reference pictures stored in a DPB.

Whether the phrase “encoding process” is intended to refer specifically to a subset of operations or generally to the broader encoding process will be clear based on the context of the specific descriptions and is believed to be well understood by those skilled in the art.

Note that the syntax elements names as used herein, are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion optimization. In particular, during the encoding process, the balance or trade-off between a rate and a distortion is usually considered. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of a reconstructed signal after coding and decoding. Faster approaches may also be used, to save encoding complexity, in particular with computation of an approximated distortion based on a prediction or a prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented, for example, in a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appeearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, retrieving the information from memory or obtaining the information for example from another device, module or from user.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, “one or more of” for example, in the cases of “A/B”, “A and/or B” and “at least one of A and B”, “one or more of A and B” is intended to encompass the selection of the first listed option (A) only, or the selection of the second listed option (B) only, or the selection of both options (A and B). As a further example, in the cases of “A, B, and/or C” and “at least one of A, B, and C”, “one or more of A, B and C” such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a use of some coding tools. In this way, in an embodiment the same parameters can be used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can include a signal indicating how managing lists of reference pictures stored in a DPB. Such a signal can be formatted, for example, as an electromagnetic wave (for example, using a radio frequency portion of spectrum) or as a baseband signal. The formatting can include, for example, encoding an encoded video stream and modulating a carrier with the encoded video stream. The information that the signal carries can be, for example, analog or digital information. The signal can be transmitted over a variety of different wired or wireless links, as is known. The signal can be stored on a processor-readable medium.

Various embodiments described below reduce the bitrate cost of signaling lists of reference pictures based at least on the temporal identifier Tid of the current picture and optionally on statuses of reference pictures. These embodiments are based on the fact that encoding structures (i.e. GOP structures) generally prevent a use of a reference picture with a higher temporal identifier Tid_ref than the temporal identifier Tid of the current picture. One can note that a temporal identifier Tid is a value generally represented by high-level syntax in the video data.

As said above, reference pictures with a temporal identifier Tid_ref higher than the temporal identifier Tid of the current picture cannot be used as reference pictures for the current picture. Consequently, these “non-allowed” reference pictures can be skipped when signaling POC differences in reference picture lists. Signaling lower values of POC difference can save significant bandwidth and hence improve compression.

In the following, various embodiments are proposed allowing, on the encoder side, to signal reference pictures taking into account allowed reference pictures only, which allows obtaining values of POC difference lower than the true values of POC difference. To do so, the various embodiments described in the following comprise signaling in the video data, for a reference picture of a list L0 or L1 associated to a current picture, an information allowing determining a POC of the reference picture, the determining of the POC being based at least on the temporal identifier Tid of the current picture and optionally, on other features of the reference picture such as its status (STRP, LTRP, ILRT, IRP or URP).

On the decoder side, signaled values of POC difference are transformed back into true values of POC difference by adding a number of skipped reference pictures to the signaled value. Several embodiments of processes for decoding POC differences are described below.

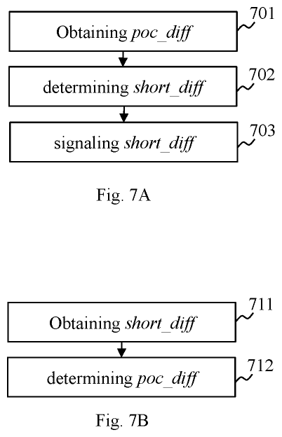

FIG. 7A illustrates a first embodiment of a method for signaling POC values implemented by an encoding module.

The method of FIG. 7A is for example executed by the processing module 500 of the system 11 when the system 11 implements the encoding method of FIG. 3.

The process of FIG. 7A is applied successively on list L0 and list L1 of a current picture and then for each list, on each reference picture of the list.

The process of FIG. 7A is adapted to regular GOP structures such as the GOP structure of table TAB2.

In a step 701, the processing module 500 obtains a real POC difference poc_diff for a current reference picture.

In a step 702, the processing module 500 calculates a shortened POC difference short_diff for the current reference picture based on the temporal identifier Tid of the current picture as follows

$$short\_diff = \frac{poc\_diff}{{2}^{highest \_ tid - Tid}} \qquad ( eq . 1 )$$

where highest_tid is the highest temporal identifier in the GOP structure.

Steps 701 and 702 allow therefore determining an information allowing obtaining the POC difference between the POC of the current reference picture of the list L0 or L1 of the current picture and the POC of the current picture. Equation eq. 1 allows accounting that reference pictures of the list L0 or L1 having a temporal identifier Tid_ref higher than the temporal identifier of the current picture Tid are skipped in the determining of the shortened POC difference in the context of regular GOP structures.

In a step 703, the processing module 500 signals the shortened POC difference short_diff for the reference picture in the information representing the list (list L0 or list L1) in place of the real POC difference poc_diff. The shortened POC difference short_diff is for instance signaled using the syntax of table TAB1.

FIG. 7B illustrates the first embodiment of the method for signaling POC values implemented by a decoding module.

The method of FIG. 7B is for example executed by the processing module 500 of the system 13 when the system 13 implements the decoding method of FIG. 4.

The process of FIG. 7B is applied successively on list L0 and list L1 of a current picture and then for each list, on each reference picture of the list.

The process of FIG. 7B is adapted to regular GOP structures such as the GOP structure of table TAB2.

In a step 711, the processing module 500 obtains a shortened POC difference for a current reference picture of the list (L0 or L1) from the information representative of the list (list L0 or list L1) of the current picture.

In a step 712, the processing module 500 calculates the real POC difference for the current reference picture using the temporal identifier Tid of the current picture as follows:

$$poc\_diff = short\_diff \times {2}^{highest \_ tid - Tid} \qquad ( eq . 2 )$$

The POC difference poc_diff is then used to determine the POC of the reference picture.

Equation eq. 2 allows accounting that reference pictures of the list L0 or L1 having a temporal identifier Tid_ref higher than the temporal identifier of the current picture Tid were skipped in the determining of the shortened POC difference in the context of regular GOP structures. Equation eq. 2 allows therefore determining the POC difference poc_diff from the shortened difference value and from the number of reference pictures of the list of reference pictures having a temporal identifier higher than the temporal identifier of the current picture that were skipped for determining the shortened POC difference.

Examples of lists L0 and lists L1 when applying the method for signaling POC values of the first embodiment on the GOP structure of table TAB2 are given in table TAB3.

TABLE TAB3

| | | | L0 list | | | | | | | | | L1 list | | | | | | | |
|---|---|---|---|---|---|---|---|---|---|---|---|---|---|---|---|---|---|---|---|
| Picture | | | active | | | | | | | | | active | | | | | | | |
| coding | | | ref | | | | | | | | | ref | | | | | | | |
| order | POC | Tid | number | reference POC offset (ref POC) | | | | | | | | number | reference POC offset (ref POC) | | | | | | |
| intra | 0 | 0 | | | | | | | | | | | | | | | | | |
| 1 | 32 | 0 | 1 | 1 | (0) | | | | | | | 1 | 1 | (0) | | | | | |
| 2 | 16 | 1 | 1 | 1 | (0) | | | | | | | 1 | −1 | (32) | | | | | |
| 3 | 8 | 2 | 1 | 1 | (0) | | | | | | | 2 | −1 | (16) | −3 | (32) | | | |
| 4 | 4 | 3 | 1 | 1 | (0) | | | | | | | 3 | −1 | (8) | −3 | (16) | −7 | (32) | |
| 5 | 2 | 4 | 1 | 1 | (0) | | | | | | | 4 | −1 | (4) | −3 | (8) | −7 | (16) | −15 (32) |
| 6 | 1 | 5 | 1 | 1 | (0) | | | | | | | 2 | −1 | (2) | −3 | (4) | | | |
| 7 | 3 | 5 | 2 | 1 | (2) | 3 | (0) | | | | | 2 | −1 | (4) | −5 | (8) | | | |
| 8 | 6 | 4 | 3 | 1 | (4) | 2 | (2) | 3 | (0) | | | 3 | −1 | (8) | −5 | (16) | −13 | (32) | |
| 9 | 5 | 5 | 2 | 1 | (4) | 5 | (0) | | | | | 2 | −1 | (6) | −3 | (8) | | | |
| 10 | 7 | 5 | 2 | 1 | (6) | 3 | (4) | | | | | 2 | −1 | (8) | −9 | (16) | | | |
| 11 | 12 | 3 | 3 | 1 | (8) | 2 | (4) | 3 | (0) | | | 2 | −1 | (16) | −5 | (32) | | | |
| 12 | 10 | 4 | 4 | 1 | (8) | 2 | (6) | 3 | (4) | 5 | (0) | 3 | −1 | (12) | −3 | (16) | −11 | (32) | |
| 13 | 9 | 5 | 2 | 1 | (8) | 5 | (4) | | | | | 2 | −1 | (10) | −3 | (12) | | | |
| 14 | 11 | 5 | 2 | 1 | (10) | 3 | (8) | | | | | 2 | −1 | (12) | −5 | (16) | | | |
| 15 | 14 | 4 | 4 | 1 | (12) | 2 | (10) | 3 | (8) | 7 | (0) | 2 | −1 | (16) | −9 | (32) | | | |
| 16 | 13 | 5 | 2 | 1 | (12) | 5 | (8) | | | | | 2 | −1 | (14) | −3 | (16) | | | |
| 17 | 15 | 5 | 2 | 1 | (14) | 3 | (12) | | | | | 2 | −1 | (16) | −17 | (32) | | | |
| 18 | 24 | 2 | 3 | 1 | (16) | 2 | (8) | 3 | (0) | | | 1 | −1 | (32) | | | | | |
| 19 | 20 | 3 | 3 | 1 | (16) | 3 | (8) | 5 | (0) | | | 2 | −1 | (24) | −3 | (32) | | | |
| 20 | 18 | 4 | 3 | 1 | (16) | 5 | (8) | 9 | (0) | | | 3 | −1 | (20) | −3 | (24) | −7 | (32) | |
| 21 | 17 | 5 | 2 | 1 | (16) | 9 | (8) | | | | | 2 | −1 | (18) | −3 | (20) | | | |
| 22 | 19 | 5 | 2 | 1 | (18) | 3 | (16) | | | | | 2 | −1 | (20) | −5 | (24) | | | |
| 23 | 22 | 4 | 3 | 1 | (20) | 3 | (16) | 11 | (0) | | | 3 | −1 | (24) | −5 | (32) | 2 | (18) | |
| 24 | 21 | 5 | 2 | 1 | (20) | 5 | (16) | | | | | 2 | −1 | (22) | −3 | (24) | | | |
| 25 | 23 | 5 | 2 | 1 | (22) | 3 | (20) | | | | | 2 | −1 | (24) | −9 | (32) | | | |
| 26 | 28 | 3 | 4 | 1 | (24) | 2 | (20) | 3 | (16) | 7 | (0) | 1 | −1 | (32) | | | | | |
| 27 | 26 | 4 | 4 | 1 | (24) | 3 | (20) | 5 | (16) | 13 | (0) | 2 | −1 | (28) | −3 | (32) | | | |
| 28 | 25 | 5 | 2 | 1 | (24) | 5 | (20) | | | | | 2 | −1 | (26) | −3 | (28) | | | |
| 29 | 27 | 5 | 2 | 1 | (26) | 3 | (24) | | | | | 2 | −1 | (28) | −5 | (32) | | | |
| 30 | 30 | 4 | 4 | 1 | (28) | 3 | (24) | 7 | (16) | 15 | (0) | 1 | −1 | (32) | | | | | |
| 31 | 29 | 5 | 2 | 1 | (28) | 5 | (24) | | | | | 2 | −1 | (30) | −3 | (32) | | | |
| 32 | 31 | 5 | 2 | 1 | (30) | 3 | (28) | | | | | 1 | −1 | (32) | | | | | |
| 33 | 64 | 0 | 2 | 1 | (32) | 2 | (0) | | | | | 1 | 1 | (32) | | | | | |
| 34 | 48 | 1 | 3 | 1 | (32) | 2 | (16) | 3 | (0) | | | 1 | −1 | (64) | | | | | |
| 35 | 40 | 2 | 4 | 1 | (32) | 3 | (16) | 2 | (24) | 5 | (0) | 2 | −1 | (48) | −3 | (64) | | | |
| 36 | 36 | 3 | 3 | 1 | (32) | 2 | (28) | 5 | (16) | | | 3 | −1 | (40) | −3 | (48) | −7 | (64) | |
| 37 | 34 | 4 | 3 | 1 | (32) | 3 | (28) | 9 | (16) | | | 4 | −1 | (36) | −3 | (40) | −7 | (48) | −15 (64) |

As can be seen, the signaled shortened POC difference values short_poc are lower than the real POC difference values diff_poc rerepsented in Table TAB2. Consequently, cost in terms of bitrate of the signaling of list L0 and L1 is reduced.

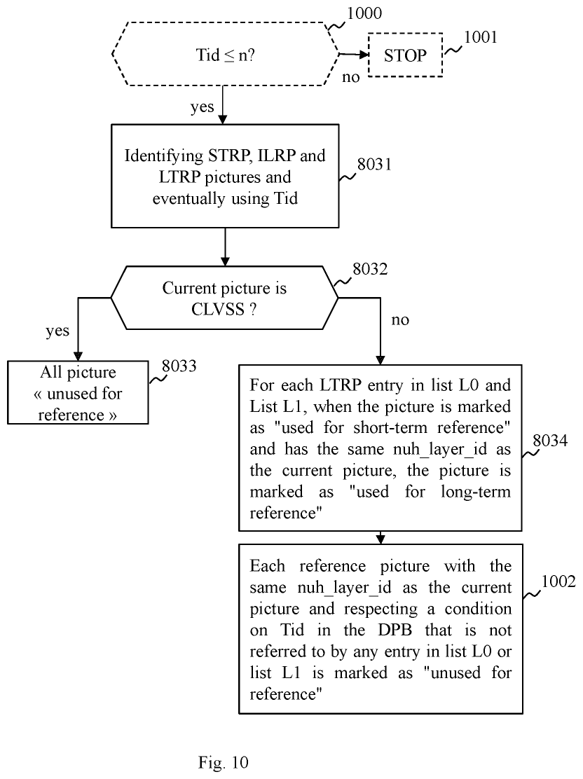

Note that inactive reference pictures that have a temporal identifier Tid_ref lower than or equal to the temporal identifier Tid of the current picture can be signaled, but the reference pictures having a temporal identifier Tid_ref higher than the temporal identifier Tid of the current picture cannot be signaled anymore because of the first embodiment. To address that, a modified reference picture marking process is proposed in the following in relation to FIG. 10.

The first embodiment is particularly adapted to regular GOP structures. In addition, the first embodiment would work only if the difference between two consecutive reference picture POCs remains the same and is equal to one. One can note that having a difference greater than one between two consecutive picture POCs requires more bits to signal the lists L0 and L1, which is not addressed by the first embodiment.

In a second embodiment, more flexibility in the GOP structure is allowed. For example, the second embodiment is compatible with a non-consecutive picture POCs signaling (for example, POCs can be signaled as 0, 10, 20, 30 . . . ). In addition, in this second embodiment, only available reference pictures are accounted in the POC difference calculation. Specifically, in addition to reference pictures with a temporal identifier Tid_ref higher than the temporal identifier Tid of the current picture, reference pictures that have been marked as URP are also skipped.

If we take the example GOP structure of Table TAB2, the POC difference can be deduced (by the encoder) for each reference picture by accounting previously coded pictures respecting the following criterion:
having a POC value between the POC value of the current picture and the POC value of the reference picture;
having the same layer identifier layerId as the current picture;
having a temporal identifier Tid_ref lower or equal to the temporal identifier Tid of the current picture;
being marked as “referenced” (i.e. STRP, LTRP, ILRP or IRP) in the DPB.

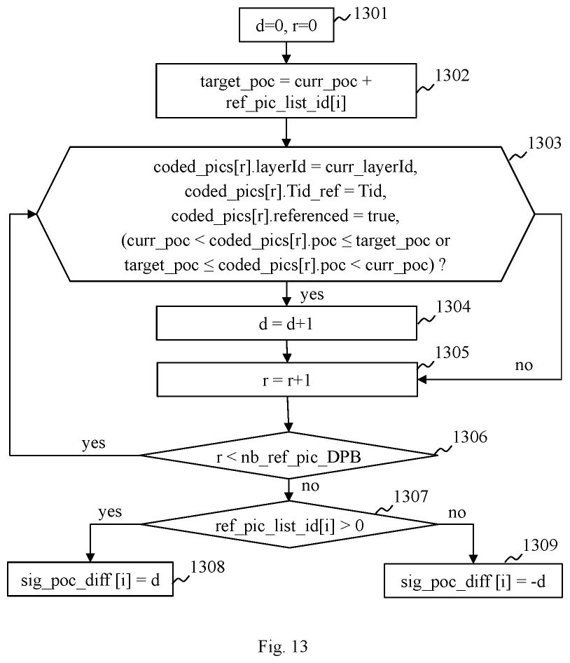

FIG. 13 illustrates an example of a reference picture index encoding process.

The reference picture index encoding process of FIG. 13 is executed by the processing module 500 of the system 11 when the system 11 implements an encoding module for example implementing the method of FIG. 3.

The process of FIG. 13 is applied successively for the construction of list L0 and list L1.

The inputs of the process of FIG. 13 are:
the current picture curr_pic having a POC=curr_poc, a layer identifier layerId=curr_layerId, and the temporal identifier Tid;
a list ref_pic_list_id of POC differences with respect to the POC of the current picture, considering all pictures, for the list L0 and L1 of the current picture;
a list coded_pics of previously coded pictures (i.e. reference pictures) in the DPB 319, each reference picture of the list coded_pics having a POC, a status (referenced (STRP, LTRP, ILRP, IRP) or not reference (URP)), a layer identifier and a temporal identifier.

Output of the process of FIG. 13 is a list sig_poc_diff of signaled POC differences (i.e. a list of shortened POC differences) for the list L0 and L1 of the current picture.

The process of FIG. 13 is applied to each POC difference ref_pic_list_id[i] of the list ref_pic_list_id, ref_pic_list_id comprising nb_ref_pictures POC differences, nb_ref_pictures corresponding to the number of reference pictures in the list L0 (respectively in the list L1). One can note that each list L0 and L1 can comprise a different number of reference pictures.

In a step 1301, the processing module 500 initialize a variable d and a variable r to “0”.

In a step 1302, the processing module 500 computes a variable target_poc as follows:

target_poc curr_poc+ref_pic_list_id[i]

In step 1303, the processing module 500 determines if the reference picture coded_pics[r]:
has a layer identifier equal to the layer identifier of the current picture curr_layerId;
has a temporal identifier Tid_ref equal to the temporal identifier Tid of the current picture;
is referenced (i.e. is either STRP, LTRP, ILRP or IRP);
has a POC poc such that curr_poc<poc≤target_poc or such that target_poc≤poc<curr_poc.

If yes, the processing module 500 increments the variable d of one unit in a step 1304 and continues with a step 1305. Otherwise, the processing module 500 executes directly step 1305.

During step 1305, the processing module 500 increments the variable r of one unit.

In a step 1306, the processing module 500 determines if r is less than the number of picture in the DPB 419 nb_ref_pic_DPB. If yes, step 1306 is followed by step 1303.

Otherwise, step 1306 is followed by step 1307.

In step 1307, the processing module 500 determines if the POC difference ref_pic_list_id[i] is positive.

If yes, in a step 1308, the signaled POC difference sig_poc_diff[i] is set to d. Otherwise, the signaled POC difference sig_poc_diff[i] is set to −d in a step 1309.

The signaled POC differences represented by sig_poc_diff are then encoded in the information representative of the list L0 and L1.

An example of lists L0 and lists L1 according to the second embodiment is illustrated in Table TAB4.

TABLE TAB4

| | | | L0 list | | | | | | | | L1 list | | | | | | | |
|---|---|---|---|---|---|---|---|---|---|---|---|---|---|---|---|---|---|---|
| Picture | | | active | | | | | | | | active | | | | | | | |
| coding | | | ref | | | | | | | | ref | | | | | | | |
| order | POC | Tid | number | reference POC offset (ref POC) | | | | | | | numb | reference POC offset (ref POC) | | | | | | |
| intra | 0 | 0 | | | | | | | | | | | | | | | | |
| 1 | 32 | 0 | 1 | 1 | (0) | | | | | | 1 | 1 | (0) | | | | | |
| 2 | 16 | 1 | 1 | 1 | (0) | | | | | | 1 | −1 | (32) | | | | | |
| 3 | 8 | 2 | 1 | 1 | (0) | | | | | | 2 | −1 | (16) | −2 | (32) | | | |
| 4 | 4 | 3 | 1 | 1 | (0) | | | | | | 3 | −1 | (8) | −2 | (16) | −3 | (32) | |
| 5 | 2 | 4 | 1 | 1 | (0) | | | | | | 4 | −1 | (4) | −2 | (8) | −3 | (16) | −4 (32) |
| 6 | 1 | 5 | 1 | 1 | (0) | | | | | | 2 | −1 | (2) | −2 | (4) | | | |
| 7 | 3 | 5 | 2 | 1 | (2) | 3 | (0) | | | | 2 | −1 | (4) | −2 | (8) | | | |
| 8 | 6 | 4 | 3 | 1 | (4) | 2 | (2) | 3 | (0) | | 3 | −1 | (8) | −2 | (16) | −3 | (32) | |
| 9 | 5 | 5 | 2 | 1 | (4) | 4 | (0) | | | | 2 | −1 | (6) | −2 | (8) | | | |
| 10 | 7 | 5 | 2 | 1 | (6) | 3 | (4) | | | | 2 | −1 | (8) | −2 | (16) | | | |
| 11 | 12 | 3 | 3 | 1 | (8) | 2 | (4) | 3 | (0) | | 2 | −1 | (16) | −2 | (32) | | | |
| 12 | 10 | 4 | 4 | 1 | (8) | 2 | (6) | 3 | (4) | 5 (0) | 3 | −1 | (12) | −2 | (16) | −3 | (32) | |
| 13 | 9 | 5 | 2 | 1 | (8) | 4 | (4) | | | | 2 | −1 | (10) | −2 | (12) | | | |
| 14 | 11 | 5 | 2 | 1 | (10) | 3 | (8) | | | | 2 | −1 | (12) | −2 | (16) | | | |
| 15 | 14 | 4 | 4 | 1 | (12) | 2 | (10) | 3 | (8) | 6 (0) | 2 | −1 | (16) | −2 | (32) | | | |
| 16 | 13 | 5 | 2 | 1 | (12) | 4 | (8) | | | | 2 | −1 | (14) | −2 | (16) | | | |
| 17 | 15 | 5 | 2 | 1 | (14) | 3 | (12) | | | | 2 | −1 | (16) | −2 | (32) | | | |
| 18 | 24 | 2 | 3 | 1 | (16) | 2 | (8) | 3 | (0) | | 1 | −1 | (32) | | | | | |
| 19 | 20 | 3 | 3 | 1 | (16) | 3 | (8) | 5 | (0) | | 2 | −1 | (24) | −2 | (32) | | | |
| 20 | 18 | 4 | 3 | 1 | (16) | 4 | (8) | 5 | (0) | | 3 | −1 | (20) | −2 | (24) | −3 | (32) | |
| 21 | 17 | 5 | 2 | 1 | (16) | 3 | (8) | | | | 2 | −1 | (18) | −2 | (20) | | | |
| 22 | 19 | 5 | 2 | 1 | (18) | 3 | (16) | | | | 2 | −1 | (20) | −2 | (24) | | | |
| 23 | 22 | 4 | 3 | 1 | (20) | 3 | (16) | 5 | (0) | | 3 | −1 | (24) | −2 | (32) | 2 | (18) | |
| 24 | 21 | 5 | 2 | 1 | (20) | 4 | (16) | | | | 2 | −1 | (22) | −2 | (24) | | | |
| 25 | 23 | 5 | 2 | 1 | (22) | 3 | (20) | | | | 2 | −1 | (24) | −2 | (32) | | | |
| 26 | 28 | 3 | 4 | 1 | (24) | 2 | (20) | 3 | (16) | 5 (0) | 1 | −1 | (32) | | | | | |
| 27 | 26 | 4 | 4 | 1 | (24) | 3 | (20) | 5 | (16) | 7 (0) | 2 | −1 | (28) | −2 | (32) | | | |
| 28 | 25 | 5 | 2 | 1 | (24) | 3 | (20) | | | | 2 | −1 | (26) | −2 | (28) | | | |
| 29 | 27 | 5 | 2 | 1 | (26) | 3 | (24) | | | | 2 | −1 | (28) | −2 | (32) | | | |
| 30 | 30 | 4 | 4 | 1 | (28) | 3 | (24) | 5 (16) | | 7 (0) | 1 | −1 | (32) | | | | | |
| 31 | 29 | 5 | 2 | 1 | (28) | 3 | (24) | | | | 2 | −1 | (30) | −2 | (32) | | | |
| 32 | 31 | 5 | 2 | 1 | (30) | 3 | (28) | | | | 1 | −1 | (32) | | | | | |
| 33 | 64 | 0 | 2 | 1 | (32) | 2 | (0) | | | | 1 | 1 | (32) | | | | | |
| 34 | 48 | 1 | 3 | 1 | (32) | 2 | (16) | 3 | (0) | | 1 | −1 | (64) | | | | | |
| 35 | 40 | 2 | 4 | 1 | (32) | 3 | (16) | 2 | (24) | 5 (0) | 2 | −1 | (48) | −2 | (64) | | | |
| 36 | 36 | 3 | 3 | 1 | (32) | 2 | (28) | 5 | (16) | | 3 | −1 | (40) | −2 | (48) | −3 | (64) | |
| 37 | 34 | 4 | 3 | 1 | (32) | 3 | (28) | 5 | (16) | | 4 | −1 | (36) | −2 | (40) | −3 | (48) | −4 (64) |

As can be seen, shortened POC difference values short_poc representative of the POC values are even lower than in the first embodiment. We can see that in the case of lists L1, the signaled shortened POC difference values are almost always consecutive (−1, −2, −3, −4), having thus a need of “1” bit to signal for each reference picture's POC difference.

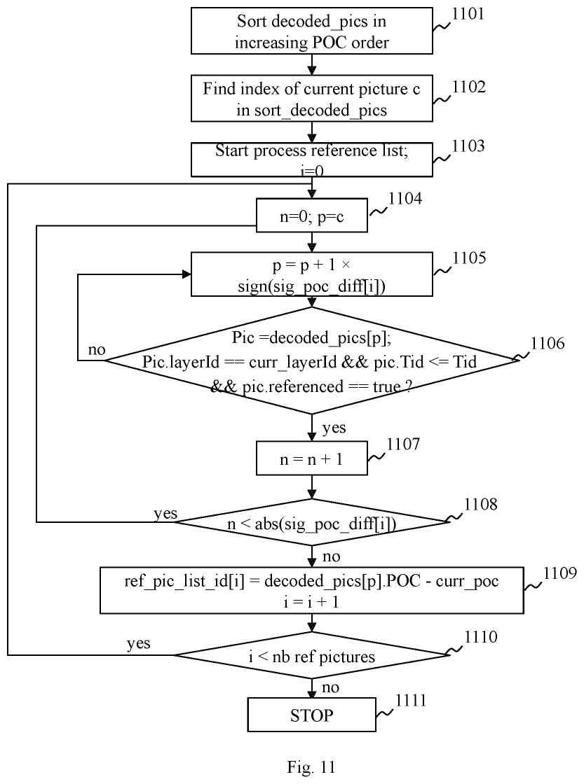

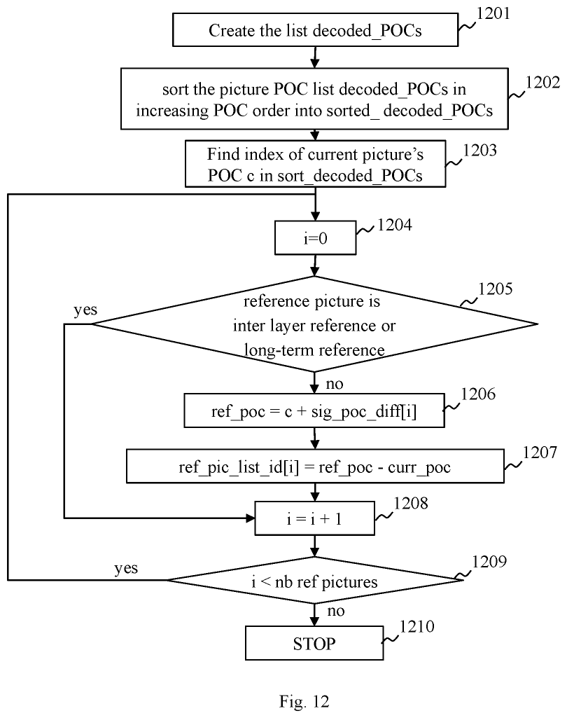

A decoder receiving these reference picture lists can reconstruct the real POC difference values diff_poc by using various embodiments of a reference picture index decoding process described below in relation to FIGS. 11 and 12. The reference picture index decoding process is executed by the processing module 500 when this processing module 500 applies a decoding module for example implementing the method of FIG. 4.

The reference picture index decoding process transforms a signaled reference picture POC difference, when reference pictures with temporal identifier Tid_ref higher than the temporal identifier Tid of the current picture and URP frames are skipped, into a real reference picture POC difference. The reference picture index decoding process is applied for lists L0 and L1. The basic idea of this process is to seek over admissible pictures the number of times indicated in the signaled reference list.

The inputs to this process are:
curr_pic: the current picture having POC=curr_poc, layer identifier curr_layerId (coding layer, used in multilayer coding, for example scalable), and temporal identifier Tid.
decoded_pics: the list of previously coded (resp. decoded in the decoder case) pictures with their POC, referenced status (referenced (STRP, LTRP, ILRP, IRP) or URP), layer identifier layerId, and temporal identifier Tid_ref
sig_poc_diff the list of signaled POC differences for the list L0 or L1 applying to the current picture.

The output of this process is a list ref_pic_list_id of real reference picture POC difference values with respect to the POC of the current picture for each list among list L0 and list L1.

FIG. 11 illustrates a first example of a reference picture index decoding process.

The process of FIG. 11 is applied successively for the reconstruction of list L0 and list L1.

The first example of the reference picture index decoding process assumes that the current picture has already been added into a list of pictures decoded_pics representing pictures stored in the DPB 419 when decoding the current picture.

In a step 1101, the processing module 500 sorts a list of pictures decoded_pics in increasing POC order into a list of pictures sort_decoded_pics.

In a step 1102, the processing module 500 determines an index c of the current picture in the sorted list sort_decoded_pics.

In a step 1103, the processing module 500 initialize a variable i to “0” allowing parsing all pictures signaled in the list (i.e. the list L0 or the list L1).

In a step 1104, the processing module 500 initializes a variable n to “0” and a variable p to c.

In a step 1105, the processing module 500 increments (respectively decrements) the value of the variable p of one unit if the signaled shortened POC difference sig_poc_diff[i] is positive (respectively negative).

In a step 1106, the processing module 500 determines if the decoded picture decoded_pics[p] has a layer identifier equal to the layer identifier of the current picture curr_layerId, a temporal identifier less or equal to the temporal identifier of the current picture Tid, and is referenced (i.e. has the status STRP, LTRP, ILRP or IRP). If yes, step 1106 is followed by a step 1107 during which the processing module 500 increments the variable n of one unit. Otherwise, step 1106 is followed by step 1105.

Step 1107 is followed by a step 1108 during which the processing module 500 determines if the absolute value of the signaled shortened POC difference sig_poc_diff[i] is higher than n.

If yes, step 1108 is followed by step 1104. Otherwise, step 1108 is followed by a step 1109.

During step 1109, the processing module 500 calculates the real POC difference ref_pic_list_id[i] of the i^{st} reference picture signaled in the list (L0 or L1) as the difference between the POC of the decoded picture decoded_pics[p] and the POC of the current picture curr_poc. During the same step, the variable i is incremented of one unit.

In a step 1110, the processing module 500 determines if the variable i is less than the number of reference pictures nb_ref_pictures in the list (L0 or L1).

If yes, step 1110 is followed by step 1104.

Otherwise, step 1110 is followed by step 1111 which stops the reference picture index decoding process.

In a variant of the first example of a reference picture index decoding process, it is assumed that the current picture has not already been added to the picture list (decoded_pics), because it is not decoded yet. The process of the second example is identical to the process illustrated in FIG. 11 except for steps 1102 and 1104.

In step 1102, the processing module 500 determines an index c of the picture having the highest POC that is lower than the POC of current picture curr_poc and having the same layer identifier than layer identifier of current picture curr_layerId.

In step 1104, the processing module 500 initializes the variable n to “0” and the variable p to c responsive to sig_poc_diff[i]>=0 and to c+1 responsive to sig_poc_diff[i]<0.

FIG. 12 illustrates a second example of a reference picture index decoding process.

The process of FIG. 12 is applied successively to list L0 and list L1.

In a step 1201, the processing module 500 creates a list of POCs decoded POCs. To do so, for each decoded picture of the DPB 419, the processing module 500 add the POC of the decoded picture to the list decoded POCs:
if the layer identifier of the decoded picture is equal to the layer identifier layerid of the current picture;
if the temporal identifier of the decoded picture is lower or equal to the temporal identifier Tid of the current picture; and,
if the reference picture is referenced (i.e. STRP, LTRP, ILRP or IRP).

In addition, in step 1201, the processing module adds the POC of the current picture curr_poc to the list decoded POCs.

In a step 1202, the processing module 500 sorts the list of POCs decoded POCs in order of increasing POCs in a list sorted decoded POCs.

In a step 1203, the processing module 500 determines an index c of the POC of the current picture in the list sorted decoded POCs.

In a step 1204, the processing module 500 initializes a variable i allowing parsing all pictures signaled in the list (L0 or L1) to “0”.

In a step 1205, the processing module 500 determines if the i^{st} reference picture of the list (L0 or L1) is an ILRP or a LTRP.

If the i^{st} reference picture is an ILRP or a LTRP, the processing module 500 continues with a step 1208 during which the variable i is incremented of one unit.

Otherwise, if the i^{st} reference picture is not an ILRP or a LTRP, the processing module 500 computes, in a step 1206, a value ref_poc for the i^{st} reference picture as follows:

$$Ref\_poc = c + sig\_poc \_diff [ i ]$$

In a step 1207 the processing module 500 calculates the real POC difference ref_pic_list_id[i] of the i^{st} reference picture of the list (L0 or L1) as the difference between the ref_poc and the POC of the current picture curr_poc.

Step 1207 is followed by step 1208.

In a step 1209, the processing module 500 determines if the variable i is less than the number of reference pictures nb_ref__pictures in the list (L0 or L1).

If yes, step 1209 is followed by step 1204.

Otherwise, step 1209 is followed by step 1210 which stops the reference picture index decoding process.

As can be seen on Table TAB2, some lists L0 or L1 contain IRP with a temporal identifier Tid_ref greater than the temporal identifier Tid of the current picture. Since in the various embodiments allowing signaling POCs in reference picture lists described above it is not possible to reference pictures with temporal identifier Tid_ref higher than the temporal identifier Tid of the current picture, the reference picture marking process is adapted to make sure that all the needed pictures stay in the DPB for future reference. Therefore, the reference picture marking process is modified so that reference pictures with a temporal identifier Tid_ref greater than the temporal identifier Tid of the current picture are not updated in the DPB. FIG. 10 below illustrates embodiments of a modified marking process adapted to the embodiments allowing signaling POC differences in reference picture lists described above.

FIG. 10 illustrates schematically a marking process for updating the status of pictures of the DPB (319 or 419) using a temporal identifier of at least one of the current picture or a reference picture stored in the DPB (319 or 419).

The marking process of FIG. 10 replaces the marking process of FIG. 9 in steps 803 and 813. The marking process of FIG. 10 is therefore executed either by the processing module 500 of the encoding module implemented by the system 11 or by the processing module 500 of the decoding module implemented by the system 13.

In the process of FIG. 10, steps 8031, 8032, 8033 and 8034 are kept.

Step 8035 is replaced by a step 1002. In step 1002, each reference picture in the DPB (319 or 419) with the same nuh_layer_id as the current picture and respecting a criterion depending on the temporal identifier Tid of the current picture or depending on the temporal identifier Tid_ref of the reference picture that is not referred to by any entry in list L0 or list L1 is marked as URP.

Various criterion depending on the temporal identifier Tid of the current picture or depending on the temporal identifier Tid_ref of the reference picture can be used.

In a first embodiment, in step 1002 each reference picture in the DPB (319 or 419) with the same nuh_layer_id as the current picture and having a temporal identifier Tid_ref equal to the temporal identifier Tid of the current picture (Tid_ref=Tid) that is not referred to by any entry in list L0 or list L1 is marked as URP. The advantage of this embodiment is that the status of a reference picture having a given temporal identifier Tid_ref value is only updated when decoding the next picture having the same temporal identifier Tid value (that might refer to the said reference picture). In the example of lists L0 and L1 of Table TAB2, with this embodiment, inactive picture referencing is unnecessary which save some bandwidth in the signaling of information representing the lists, L0 and L1.

In a second embodiment, in step 1002 each reference picture in the DPB (319 or 419) with the same nuh_layer_id as the current picture and having a temporal identifier Tid reflower than or equal to the temporal identifier Tid of the current picture (Tid_ref≤Tid) that is not referred to by any entry in list L0 or list L1 is marked as URP. Thus, the marking process only modifies the status of reference pictures to which the current picture can refer to.

We described above a number of embodiments. Features of these embodiments can be provided alone or in any combination. Further, embodiments can include one or more of the following features, devices, or aspects, alone or in any combination, across various claim categories and types:
A TV, set-top box, cell phone, tablet, or other electronic device that performs at least one of the embodiments described.
A TV, set-top box, cell phone, tablet, or other electronic device that performs at least one of the embodiments described, and that displays (e.g. using a monitor, screen, or other type of display) a resulting picture.
A TV, set-top box, cell phone, tablet, or other electronic device that tunes (e.g. using a tuner) a channel to receive a signal including an encoded video stream, and performs at least one of the embodiments described.
A TV, set-top box, cell phone, tablet, or other electronic device that receives (e.g. using an antenna) a signal over the air that includes an encoded video stream, and performs at least one of the embodiments described.

1. A method comprising:
determining an information representative of a picture order count difference between a picture order count of a current reference picture of a list of reference pictures associated to a current picture and a picture order count of the current picture; and,
signaling the information in video data in data representative of the list of reference pictures;
wherein:
the information is a shortened picture order count difference calculated as a division of the picture order count difference by a value depending on a difference between a highest temporal identifier value in a group of picture's structure comprising the current picture and a temporal identifier of the current picture.

2. (canceled)

3. The method of claim 1, wherein reference pictures of the list of reference pictures having a temporal identifier higher than the temporal identifier of the current picture are skipped for the determining of the information.

4. The method of claim 1, wherein the determining of the information is further based on at least one of a status of reference pictures of the list of reference pictures among a plurality of statuses comprising a status indicating that a reference picture concerned by this status is unused for reference and a layer identifier of reference pictures of the list of reference pictures.

5. The method of claim 3, wherein the determining of the information is further based on at least one of a status of reference pictures of the list of reference pictures among a plurality of statuses comprising a status indicating that a reference picture concerned by this status is unused for reference and a layer identifier of reference pictures of the list of reference pictures, and wherein the reference pictures of the list of reference pictures having the status unused for reference or a layer identifier different from the layer identifier of the current picture are also skipped for the determining of the information.

6. A method comprising:
obtaining from video data an information representative of a picture order count difference between a picture order count of a current reference picture of a list of reference pictures associated to a current picture and a picture order count of the current picture;
determining the picture order count difference from the information; and,
determining a picture order count of the current reference picture from the picture order count difference;
wherein,
the information is a shortened picture order count difference calculated as a division of the picture order count difference by a value depending on a difference between a highest temporal identifier value in a group of picture.

7. (canceled)

8. The method of claim 6, wherein the picture order count difference is determined from a number of reference pictures of the list of reference pictures having a temporal identifier higher than the temporal identifier of the current picture.

9. The method of claim 6, wherein the picture order count difference is further based on at least one of a status of reference pictures of the list of reference pictures among a plurality of statuses comprising a status indicating that a reference picture concerned by this status is unused for reference and a layer identifier of reference pictures of the list of reference pictures.

10. The method of claim 8, wherein the picture order count difference is further based on at least one of a status of reference pictures of the list of reference pictures among a plurality of statuses comprising a status indicating that a reference picture concerned by this status is unused for reference and a layer identifier of reference pictures of the list of reference pictures, and wherein the picture order count difference is further determined from a number of reference pictures of the list of reference pictures having the status unused for reference or a layer identifier different from the layer identifier of the current picture.

11. A device comprising electronic circuitry configured for:
determining an information representative of a picture order count difference between a picture order count of a current reference picture of a list of reference pictures associated to a current picture and a picture order count of the current picture; and,
signaling the information in video data in data representative of the list of reference pictures;
wherein:
the information is a shortened picture order count difference calculated as a division of the picture order count difference by a value depending on a difference between a highest temporal identifier value in a group of picture.

12. (canceled)

13. The device of claim 11, wherein reference pictures of the list of reference pictures having a temporal identifier higher than the temporal identifier of the current picture are skipped for the determining of the information.

14. The device of claim 11, wherein the determining of the information is further based on at least one of a status of reference pictures of the list of reference pictures among a plurality of statuses comprising a status indicating that a reference picture concerned by this status is unused for reference and a layer identifier of reference pictures of the list of reference pictures.

15. The device of claim 13, wherein the determining of the information is further based on at least one of a status of reference pictures of the list of reference pictures among a plurality of statuses comprising a status indicating that a reference picture concerned by this status is unused for reference and a layer identifier of reference pictures of the list of reference pictures, and wherein the reference pictures of the list of reference pictures having the status unused for reference or a layer identifier different from the layer identifier of the current picture are also skipped for the determining of the information.

16. A device comprising electronic circuitry configured for:
obtaining from video data an information representative of a picture order count difference between a picture order count of a current reference picture of a list of reference pictures associated to a current picture and a picture order count of the current picture;
determining the picture order count difference from the information; and,
determining a picture order count of the current reference picture from the picture order count difference;
wherein,
the information is a shortened picture order count difference calculated as a division of the picture order count difference by a value depending on a difference between a highest temporal identifier value in a group of picture.

17. (canceled)

18. The device of claim 16, wherein the picture order count difference is determined from a number of reference pictures of the list of reference pictures having a temporal identifier higher than the temporal identifier of the current picture.

19. The device of claim 16, wherein the picture order count difference is further based on at least one of a status of reference pictures of the list of reference pictures among a plurality of statuses comprising a status indicating that a reference picture concerned by this status is unused for reference and a layer identifier of reference pictures of the list of reference pictures.

20-23. (canceled)
